(19) United States
(12) Patent Application Publication
(10) Pub. No.: US 2019/0346382 A1
(43) Pub. Date: Nov. 14, 2019

(54) Radiation Scanning System with Variable Field of View

(71) Applicant: Viken Detection Corporation, Newton, MA (US)

(72) Inventor: Peter J. Rothschild, Newton, MA (US)

(21) Appl. No.: 16/407,104

(22) Filed: May 8, 2019

Related U.S. Application Data
(60) Provisional application No. 62/796,578, filed on Jan. 24, 2019.
(60) Provisional application No. 62/668,574, filed on May 8, 2018.

(51) Int. Cl. G01N 23/04

(52) U.S. Cl. CPC G01N 23/04; G01N 2223/33; G01N 2223/314; G01N 2223/316

(57) ABSTRACT

A radiation scanning system includes a source to output penetrating radiation, a collimator to form a collimated, irradiating fan beam in a plane, and a disk chopper wheel defining one or more apertures that pass at least a portion of the radiation for scanning a target object. The system further includes a translation mechanism that can effect a variable, relative displacement between the disk chopper wheel and the fan beam plane, enabling the fan beam position to be continuously variable. The system may also include field of view (FOV)-limiting plates with radial edges that adjust or steer the FOV for additional flexibility. Accordingly, the FOV may be fixedly set or dynamically adjusted from scan to scan. Scatter plates and a tilted disk chopper wheel may be included to dramatically reduce system weight.

### RELATED APPLICATIONS

This application claims the benefit of U.S. Provisional Application No. 62/796,578, filed on Jan. 24, 2019. This application also claims the benefit of U.S. Provisional Application No. 62/668,574, filed on May 8, 2018. The entire teachings of the above applications are incorporated herein by reference.

### BACKGROUND

X-ray backscatter imaging has been used for detecting concealed contraband, such as drugs, explosives, and weapons, since the late 1980's. X-ray imaging generally relies on using x-rays that are incident on a target object. In traditional transmission x-ray imaging, images of the target object are created by detecting incident x-rays that penetrate through the target object. In contrast to traditional transmission x-ray imaging, backscatter imaging instead uses reflected or scattered x-rays to create the image. In either transmission or backscatter x-ray scanning, a standard x-ray tube may generate x-rays. In backscatter x-ray scanning, the x-rays may be collimated into a fan beam by a slit aperture in an attenuating plate. The fan beam may be “chopped” into a pencil beam by a rotating a “chopper wheel” that has slit apertures therein. As the slit apertures rotate with the chopper wheel, the pencil beam can be scanned over the target object that is being imaged. The intensity of the x-rays scattered in the backwards direction may then be recorded by one or more large-area backscatter detectors as a function of position of the illuminating beam. By moving the target object through a plane containing the scanning beam, either on a conveyor or under its own power, a two-dimensional backscatter image of the object may be obtained. The chopper wheel is usually of one of three basic types: a rotating disk, a rotating wheel that contains “spokes” or “collimating tubes”, or a rotating hoop.

### SUMMARY

The angular range over which the sweeping pencil beam illuminates the target object is called the Field of View (FOV) of the imaging system and is denoted herein by an angle Θ. After the pencil beam created by one slit aperture in the disk chopper wheel leaves the FOV, the pencil beam created by the next slit aperture enters the FOV. If the FOV is larger than the target object being scanned, then the beam spends a significant time not illuminating the object, and the x-rays during this time do not contribute to improving the image of the object.

Some existing systems that have attempted to provide a variable FOV have significantly limited dwell time of the sweeping pencil beam on the target object, resulting in poorer image quality compared with having the beam dwell on the target object 100% of the time. One existing system requires motion of the x-ray source on axis with the beam toward or away from a disk chopper wheel. Another existing system requires multiple sets of slit apertures in a disk chopper wheel or a hoop chopper wheel and requires multiple synchronization signals, increasing system complexity. Further, existing systems have not allowed a central axis of the FOV to be steered.

Therefore, it would be advantageous to have a scanning system with a variable FOV permitting an x-ray scanning beam to spend all or most of the time illuminating the object of interest, regardless of the target object's size. There is further a need for a variable FOV that allows the central FOV axis to be steerable and that is simpler than existing designs.

Consistent with embodiments disclosed herein, a rotating disk chopper wheel may be altered and implemented in a system, assembly, or corresponding method to allow the FOV of the imaging system to be adjusted at the factory or to be adjusted and varied dynamically, on a scan-to-scan basis, depending on the size or position of the target object to be scanned.

Disclosed herein are novel means of performing x-ray imaging with a continuously variable FOV without requiring multiple sets of slit apertures in the disk or hoop chopper wheel. In addition, the apparatus and method disclosed herein has the capability to allow the central axis of the FOV to be steered. It can also have an added advantage that no additional shielding may be required to enclose any moving parts, making it a relatively small and compact assembly. Because embodiments may rely on only one set of slit apertures in the disk chopper wheel, it is possible to rely on one synchronization signal alone.

In one embodiment, a radiation scanning system includes a source configured to output penetrating radiation; a collimator configured to collimate the penetrating radiation to form a collimated, irradiating fan beam of the penetrating radiation, the fan beam oriented in a fan beam plane; and a disk chopper wheel that is configured to block the fan beam of penetrating radiation, the disk chopper wheel configured to receive the irradiating fan beam at a fan beam position on a source side of the disk chopper wheel, the disk chopper wheel defining one or more apertures therein that are configured to pass at least a portion of the penetrating radiation from the irradiating fan beam from the source side to an output side of the disk chopper wheel for scanning a target object. The system further includes a translation mechanism configured to effect a variable, relative displacement between the disk chopper wheel and the fan beam plane, the variable, relative displacement enabling the fan beam position to be continuously variable.

The disk chopper wheel may be configured to rotate in a rotation plane perpendicular to a rotation axis of the disk chopper wheel, the apertures being radial slit apertures, the system having a full field of view (FOV) defined by an angular range through which a pencil beam output from the disk chopper wheel sweeps upon rotation of the disk chopper wheel, the pencil beam formed by a cross-sectional intersection between the fan beam and a given one of the radial slit apertures. The system may further include one or more FOV-limiting plates positioned relative to the disk chopper wheel and defining at least two radial edges, the at least two radial edges defining a limited FOV over which the pencil beam may be output from the disk chopper wheel, the limited FOV being smaller than the full FOV.

The translation mechanism can be further configured to effect the variable, relative displacement between the disk chopper wheel and the fan beam plane in a direction substantially normal to the fan beam plane.

The translation mechanism may be an electromechanical actuator, a manual actuator, or a slide mechanism.

The disk chopper wheel may be configured to rotate about a rotation axis thereof, with the rotation axis being perpendicular to a rotation plane in which the disk chopper wheel is oriented.

The fan beam may be substantially oriented in a fan beam plane, and the rotation plane of the disk chopper wheel may be substantially non-perpendicular relative to the fan beam plane.

The translation mechanism may be further configured to effect the variable, relative displacement between the disk chopper wheel and the fan beam plane with a displacement component that is parallel to the fan beam plane. The angle between the rotation plane and the fan beam plane may be 30° to 45°, 25° to 35°, 30°, less than 30°, 15° to 25°, less than 20°, 10° to 15°, or less than 15°.

The disk chopper wheel may have a rim, and the one or more apertures may be one or more radial slit apertures, each extending toward the rim and toward the rotation axis. The one or more radial slit apertures may be further configured to pass the at least a portion of the penetrating radiation of the irradiating fan beam through the one or more radial slit apertures to form a scanning pencil beam, as a function of rotation of the disk chopper wheel, for scanning the target object over an angular field of view (FOV).

The radiation scanning system may have a full FOV determined by an angular range of rotation of the disk chopper wheel over which the irradiating fan beam intersects cross-sectionally with a radial slit aperture of the one or more radial slit apertures. The system may further include one or more FOV-limiting plates configured to block the penetrating radiation to limit the full FOV to a limited FOV that is smaller than the full scanning angular FOV. The one or more FOV-limiting plates may be configured to be angularly adjustable to change a direction of a central axis of the limited FOV or to limit the FOV further. The system may optionally include an electromechanical rotation actuator or a manual angular adjustment mechanism configured to adjust or allow the one or more FOV-limiting plates to be adjusted angularly relative to the disk chopper wheel.

The disk chopper wheel may have a solid cross-sectional area in the plane of rotation of the disk chopper wheel. The system may further optionally include a source-side scatter plate having a solid cross-sectional area in a plane parallel to the rotation plane of the disk chopper wheel, the source-side scatter plate being substantially opaque to the penetrating radiation and defining an open slot aperture therein configured to pass penetrating radiation, wherein the solid cross-sectional area of the source-side scatter plate is substantially smaller than the solid cross-sectional area of the disk chopper wheel.

The system may further include a support structure configured to secure the source-side scatter plate substantially parallel to the rotation plane of the disk chopper wheel with a source-side gap between the source-side scatter plate and the source side of the disk chopper wheel.

In one embodiment, the disk chopper wheel has a solid cross-sectional area in the plane of rotation, and the system may further optionally include an output-side scatter plate having a solid cross-sectional area in a plane parallel to the plane of rotation of the disk chopper wheel, which includes in the wheel plane, the output-side scatter plate being substantially opaque to the penetrating radiation and defining an open slot aperture therein configured to pass the penetrating radiation. In this embodiment, the solid cross-sectional area of the output-side scatter plate in the plane parallel to the rotation plane of the disk chopper wheel is substantially smaller than the solid cross-sectional area of the disk chopper wheel. The system may further include a support structure configured to secure the output-side scatter plate substantially parallel to the rotation plane of the disk chopper wheel with an output-side gap between the output-side scatter plate and the output side of the disk chopper wheel.

The translation mechanism may be further configured to effect the variable, relative displacement smoothly such that the fan beam position at which the disk chopper wheel is configured to receive the irradiating fan beam is also smoothly variable. As an alternative, the translation mechanism may be configured to effect the variable, relative displacement incrementally such that the fan beam position at which the disk chopper wheel is configured to receive the irradiating fan beam is also incrementally variable.

A mobile radiation scanning system, such as a mobile radiation scanning system, such as a van, may include a plurality of radiation scanning systems described herein. A stationary radiation scanning portal may also include a plurality of radiation scanning systems described herein.

In another embodiment, a radiation scanning method includes effecting a variable, relative displacement between a disk chopper wheel and a source, the disk chopper wheel being configured to block penetrating radiation produced by or output from the source; outputting penetrating radiation from the source; and collimating the penetrating radiation to form a collimated, irradiating fan beam oriented in a fan beam plane. The method also includes receiving the irradiating fan beam at a continuously variable fan beam position on a source side of the disk chopper wheel, the fan beam position being continuously variable as a function of the variable, relative displacement; and passing at least a portion of the penetrating radiation from the irradiating fan beam from the source side to an output side of the disk chopper wheel for scanning a target object.

The method may employ features and elements of any of the other embodiments described herein.

In another embodiment, a radiation scanning system includes means for enabling a disk chopper wheel that is configured to block the penetrating radiation to receive a collimated, irradiating fan beam of the penetrating radiation at a fan beam position on a source side of the disk chopper wheel; means for effecting a variable, relative displacement between the disk chopper wheel and the fan beam plane to vary, over a continuous range, the fan beam position at which the disk chopper wheel is enabled to receive the collimated, irradiating fan beam on the source side of the disk chopper wheel; means for outputting the penetrating radiation from the source; and means for passing at least a portion of the penetrating radiation through one or more apertures in the disk chopper wheel to scan a target object.

In still another embodiment, a radiation scanning system includes a source that is configured to output penetrating radiation; a collimator configured to collimate the penetrating radiation to form a collimated, irradiating fan beam oriented in a fan beam plane; and a disk chopper wheel that is configured to block the penetrating radiation, the disk chopper wheel configured to receive the irradiating fan beam at a fan beam position on a source side of the disk chopper wheel, the disk chopper wheel defining one or more radial slit apertures therein, the one or more radial slit apertures extending toward a rim of the disk chopper wheel and toward a rotation axis of the disk chopper wheel, the rotation axis being perpendicular to a rotation plane in which the disk chopper wheel is oriented, the one or more radial slit apertures being configured to pass at least a portion of the penetrating radiation from the irradiating fan beam from the source side to an output side of the disk chopper wheel to form a scanning pencil beam for scanning a target object over an angular field of view (FOV) as a function of a rotation of the disk chopper wheel about the rotation axis. The system has a full FOV determined by an angular range of the rotation of the disk chopper wheel over which the irradiating fan beam intersects cross-sectionally with a radial slit aperture of the one or more radial slit apertures. The system further includes one or more FOV-limiting plates configured to block the penetrating radiation to (i) limit the full FOV to a limited FOV that is smaller than the full FOV, (ii) steer a central axis of the full FOV, or both (i) and (ii).

In an additional embodiment, a radiation scanning system includes a source configured to output source penetrating radiation; a collimator configured to receive the penetrating radiation and to output a fan beam of penetrating radiation therefrom; and a disk chopper wheel defining one or more apertures therein, the disk chopper wheel configured to receive the fan beam at a position on the disk chopper wheel and to pass penetrating radiation from the fan beam through the one or more apertures for scanning a target object. The system also includes a translation mechanism configured to effect a variable, relative displacement between the disk chopper wheel and the source, in a direction substantially normal to the fan beam plane, the variable, relative displacement enabling the position of the fan beam at the disk chopper wheel, during the scanning the target, to be continuously variable over a range.

In another additional embodiment, a radiation scanning system includes a source configured to output penetrating radiation, as well as a collimator configured to receive the penetrating radiation and to output a fan beam of penetrating radiation therefrom, the fan beam substantially oriented in a fan beam plane. The system further includes a disk chopper wheel mounted on a mechanical translation mount, the disk chopper wheel oriented to receive the fan beam, the mechanical translation mount configured to translate the chopper wheel, relative to the fan beam, in a direction substantially perpendicular to the fan beam plane.

In still another additional embodiment, a radiation scanning system includes a source configured to output penetrating radiation; a collimator configured to receive the penetrating radiation and to output a fan beam of penetrating radiation therefrom, the fan beam substantially oriented in a fan beam plane; and a disk chopper wheel having a rim and a center, the disk chopper wheel defining one or more radial slit apertures extending toward the rim and toward the center, the disk chopper wheel being configured to receive the fan beam at a position on the disk chopper wheel and to pass penetrating radiation from the fan beam through the one or more radial slit apertures to form a scanning pencil beam as a function of a rotation of the disk chopper wheel, for scanning, over an angular field of view, a target object. The system further includes a translation mechanism configured to effect a variable, relative displacement between the disk chopper wheel and the source, in a direction substantially normal to the fan beam plane, the variable, relative displacement causing the angular field of view to be continuously variable over a range.

In another embodiment, a radiation scanning system includes a source configured to output a fan beam of penetrating radiation oriented in a fan beam plane; a disk chopper wheel that is configured to rotate in a rotation plane perpendicular to a rotation axis, the disk chopper wheel defining one or more radial slit apertures therein, the system having a full FOV defined by an angular range through which a pencil beam output from the disk chopper wheel sweeps upon rotation of the disk chopper wheel, the pencil beam formed by a cross-sectional intersection between the fan beam a given one of the radial slit apertures; and one or more FOV-limiting plates positioned relative to the disk chopper wheel and defining at least two radial edges, the at least two radial edges defining a limited FOV over which the pencil beam may be output from the disk chopper wheel, the limited FOV being smaller than the full FOV.

It should be understood that any of the embodiments described above may include features and elements of any of the other embodiments described above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a perspective-view illustration of an embodiment radiation scanning system with a translation mechanism enabling variable field of view (FOV) being applied to transmission imaging luggage on a conveyor belt.

FIGS. 2A-2C are illustrations of various translation mechanisms that may be used in embodiment systems.

FIGS. 3A-3B are illustrations of a vehicle scanning environment in which embodiment systems including the system of FIG. 1 may be used with great advantage to adjust a FOV of the system

FIG. 4 illustrates in greater detail how FOV may be varied in embodiment systems by displacement to change a position at which the irradiating fan beam is received at the disk chopper wheel and also by advantageously employing radial edges of FOV-limiting plates.

FIG. 5A illustrates how the disk chopper wheel assembly illustrated in FIG. 4 can be adjusted to steer a central axis of the FOV so that objects at different angular locations or heights can be imaged.

FIG. 5B is an illustration of a modified version version of the chopper wheel assembly of FIG. 4, including a shutter plate connecting the FOV-limiting plates.

FIG. 5C is an illustration of an alternative modified version of the assembly of FIG. 4, wherein the assembly includes a shutter plate that is separate from the FOV-limiting plates and the assembly includes a motor for controlling the shutter.

FIG. 6A illustrates how the angular tilt of the FOV provided by the assembly of FIGS. 4 and 5A-5C may assist in scanning applications including scanning a car having a roof-mount cargo carrier.

FIG. 6B is a schematic diagram illustrating a system incorporating automatic control of FOV using the FOV-limiting plates illustrated in FIG. 5C.

FIG. 7 is an illustration of a disk chopper wheel assembly 700 that may be incorporated advantageously into embodiment systems in order to decrease the weight of a chopper wheel while maintaining effective thickness.

FIG. 8A is a perspective illustration of a disk chopper wheel assembly having source-side and output-side scatter plates that may be incorporated into embodiment radiation scanning systems to decrease weight of shielding materials.

FIG. 8B is an exploded, perspective-view illustration of the disk chopper wheel assembly of FIG. 8A.

FIG. 9A is a cross-sectional view illustration of a disk chopper wheel, scatter plates, and a shield structure that form part of the assembly of FIGS. 8A-8B.

FIG. 9B is a magnified view of a portion of the cross-sectional illustration of FIG. 9A showing additional dimensional details and features of the assembly of FIGS. 8A-8B.

FIG. 10 is a cross-sectional view illustration of the full chopper wheel assembly illustrated in FIGS. 8A-8B.

FIG. 11 is a cross-sectional view illustration of the disk chopper wheel used in the chopper wheel assembly of FIGS. 8A-8B.

FIG. 12A is a cross-sectional view illustration of a source-side scatter plates used in the chopper wheel assembly of FIGS. 8A-8B.

FIG. 12B is a cross-sectional view illustration of an output-side scatter plate used in the chopper wheel assembly of FIGS. 8A-8B.

FIG. 13 is a magnified view of a portion of the cross-sectional illustration of FIG. 9A, further illustrating the action of the disk chopper wheel, source-side scatter plate, an output-side scatter plate, and shield assembly of the chopper wheel assembly of FIGS. 8A-8B, specifically the action of these components to substantially confine scattered x-ray radiation.

FIG. 14 is a schematic diagram illustrating an embodiment radiation scanning system mounted within a mobile scanning platform vehicle.

FIGS. 15A-15C are schematic, perspective-view illustrations of scanning geometry in an embodiment system like that of FIG. 1, in which the rotation plane of the disk chopper wheel is substantially perpendicular to the plane of the fan beam.

FIGS. 16A-16C are schematic, perspective-view illustrations of scanning geometry for a system that is modified to include for a system that is modified such that the rotation plane of the disk chopper wheel is substantially non-perpendicular with respect to the fan beam plane, particularly with an angle of 45° between them, wherein variable, relative displacement between the source and the disk chopper wheel may advantageously be in a direction that is not normal to the fan beam plane.

FIGS. 17A-17C are schematic, perspective-view illustrations of scanning geometry with the plane of rotation of the disk chopper wheel being at an angle of 30° with respect to the fan beam plane.

FIG. 18 is a flow diagram illustrating an embodiment procedure for radiation scanning.

FIG. 19 is a schematic, perspective-view illustration of a system that includes FOV-limiting plates for effecting adjustment in scanning FOV of the system.

### DETAILED DESCRIPTION

A description of example embodiments follows.

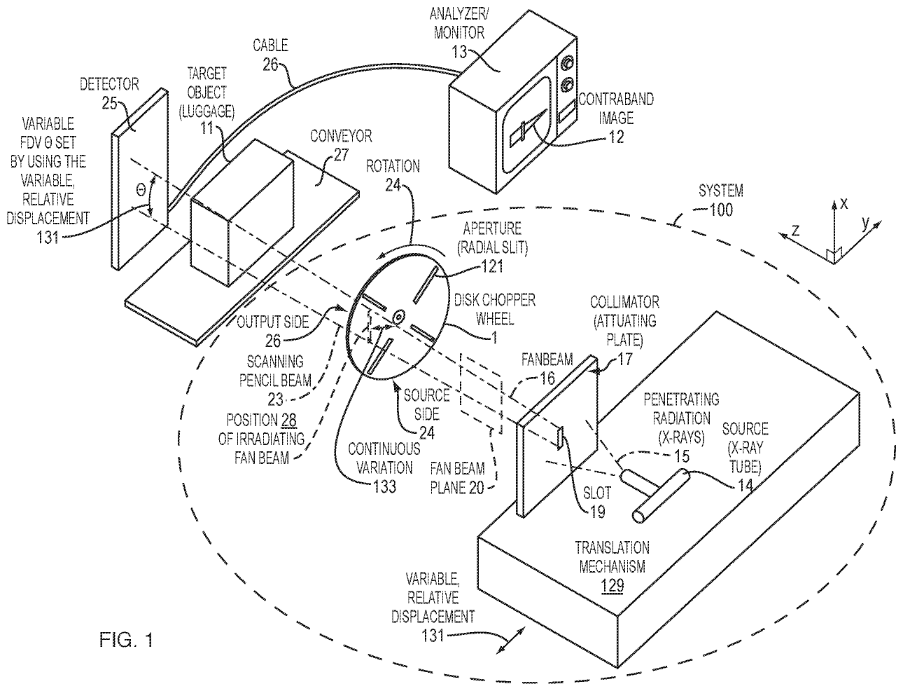

FIG. 1 is a perspective-view illustration of an embodiment radiation scanning system 100. The scanning system 100 includes a disk chopper wheel 1, a source 14 that is configured to output penetrating radiation 15, a collimator 17, and a translation mechanism 129. The system 100 is particularly configured to perform x-ray scanning, with the source 14 being an x-ray tube and the penetrating radiation 15 being x-rays. However, in other embodiments, the system may be modified and configured for scanning using other types of penetrating radiation, such as gamma rays or an electron beam with the appropriate source, collimation, and disk chopper wheel materials, for example.

The collimator 17 is an attenuating plate in this embodiment. However, the collimator 17 may take other forms in other embodiments. For example, in some embodiments, a collimator may be an integral part of the source design, for example. A fan beam may be produced by the source by virtue of its design, such that the source inherently includes a collimator or only produces output radiation in a fan beam. The source 14 and collimator 17 together produce a fan beam 16 of x-rays, which is oriented in a fan beam plane 20. The disk chopper wheel 1 is configured to receive the fan beam of penetrating radiation x-rays 16 at a position 28 at a source side 24 of the disk chopper wheel 1. The disk chopper wheel is configured to block the fan beam 16 of penetrating radiation by way of scattering, absorption, or other means. The disk chopper wheel 1 may be substantially opaque to the penetrating radiation, such as by blocking more than 50%, more than 75%, more than 90%, or more than 99% of incident x-rays, for example.

The disk chopper wheel 1 may preferably be formed of lead, tungsten, or other elements of high atomic number, for example. The disk chopper wheel 1 defines various apertures 21 therein, which are radial slits in the system 100. The radial slit apertures 21 are configured to pass at least a portion of the penetrating radiation from the irradiating fan beam 16 from the source side 24 to an output side 26 of the disk chopper wheel 1. When one of the radial slit apertures 21 intersects cross-sectionally with the illuminating position 28 of the fan beam 16 on the source side 24 of the disk chopper wheel 1, a pencil beam 23 at the output side of the disk chopper wheel 1 is formed. The pencil beam 23 may be used for scanning over a target object as a function of a rotation 24 of the disk chopper wheel. The rotation 24 of the disk chopper wheel occurs in a rotation plane that is parallel to the XY plane in FIG. 1. This rotation is perpendicular to a rotation axis of the disk chopper wheel (in this embodiment, through the geometric center of the disk chopper wheel and parallel to the Z axis in FIG. 1).

The system 100 is shown configured for a transmission scanning arrangement. In particular, the pencil beam 23 scans over a target object 11 (luggage in FIG. 1), with a vertical sweep, as the luggage target object 11 is moved along a conveyor belt 27. A portion of the pencil beam 23 that is transmitted through the target 11 is detected by a detector 25 that is located on the opposite side of the target object from the disk chopper wheel and system 100. The detector 25 is connected via a cable 26 to an analyzer/monitor 13 that analyzes the detected signals from the detector 25 and displays them to show an image 12 of items within the target object luggage 11. The image 12 may include contraband items, for example.

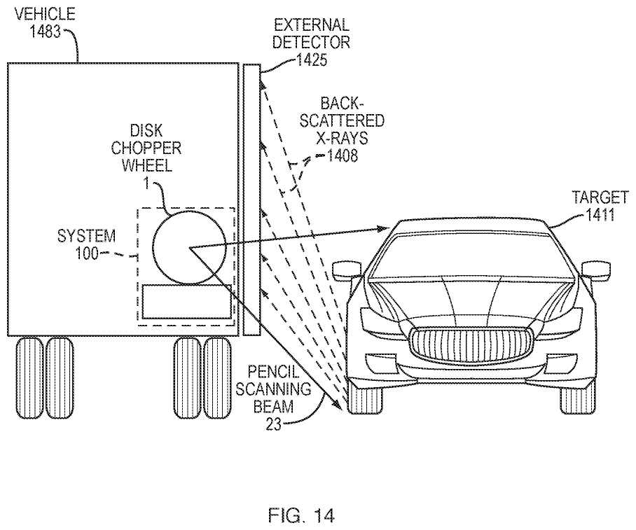

Nonetheless, in contrast to the arrangement illustrated in FIG. 1, the system 100 may also be applied to backscatter x-ray detection, for example. Backscatter detection may be performed by detecting backscatter x-rays that are backscattered from the target object 11, with a backscatter detector positioned between the target object 11 and the disk chopper wheel 1, for example. Such an arrangement is illustrated in FIG. 14, for example. Accordingly, the system 100 may be applied to transmission-based imaging, backscatter imaging, or both.

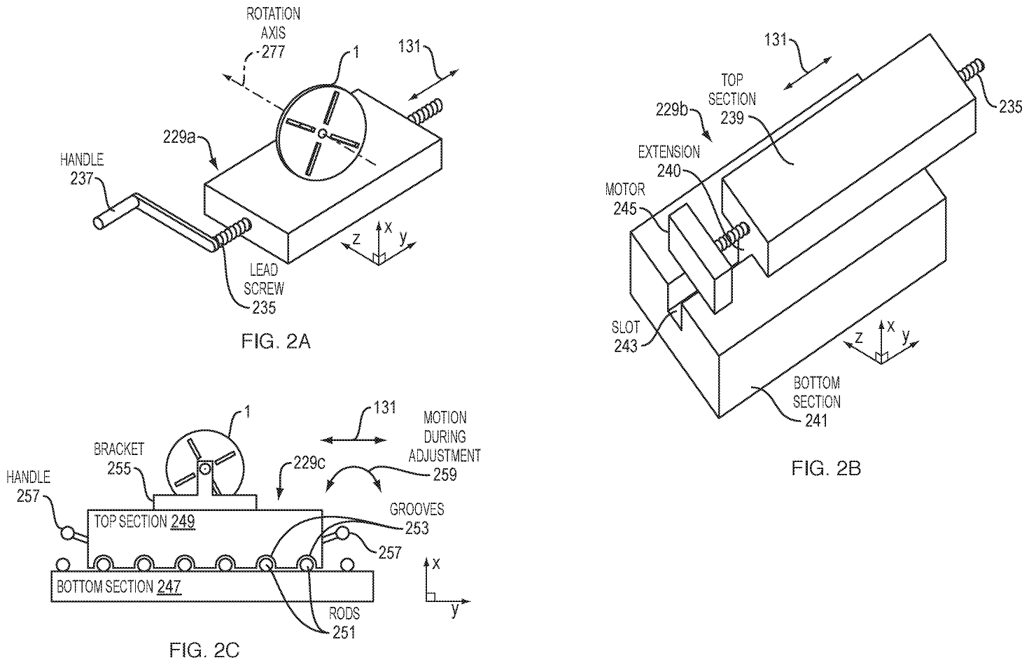

The translation mechanism 129 is configured to effect a variable, relative displacement 131 between a disk chopper wheel 1 and the fan beam plane 20. The system 100 particularly accomplishes this by effecting the variable, relative displacement between the disk chopper wheel 1 and the source 14. However, this relative displacement is effected by translating the disk chopper wheel in other embodiments, for example. While the translation mechanism 129 is shown generally in the system 100, some particular types of specific translation mechanisms are illustrated in FIGS. 2A-2C. Nonetheless, translating mechanisms are not limited to those illustrated in FIGS. 2A-2C. Instead, translation may be carried out by any appropriate means known in the arts of mechanics and motion control, for example, which will be understood readily in view of this disclosure.

The variable, relative displacement between the disk chopper wheel 1 and the fan beam plane 20 enables the fan beam position 28 at the source side of the disk chopper wheel to be continuously variable, as indicated by a continuous variation 133 in FIG. 1. The variable, relative displacement 131 and continuous variation 133 have multiple advantages, including the ability to vary a field of view (FOV) of the radiation scanning system 100 with greater flexibility and simplicity than is possible with existing systems. These advantages are described further hereinafter.

In the system 100, the source 14 and collimator 17 are mounted to the translation mechanism 129. In this manner, the source 14 and collimator 17 are translated (displaced) together relative to the disk chopper wheel 1. In other embodiments, the disk chopper wheel 1 is mounted or otherwise coupled or connected to a translation mechanism for changing the position 28 of the irradiating fan beam with the continuous variation 133.

As used herein, “continuous variation” means that the position 28 of the irradiating fan beam may be one position of two or more positions on the disk chopper wheel 1 at which the fan beam 16 can be made to intersect cross-sectionally with a given radial slit 21 during scans of target objects. Accordingly, for a given radial slit 21, the position 28 of the irradiating fan beam may be set to intersect the slit at two or more positions 28, selectively, for choosing a field of view of the system 100.

The FOV of the system 100 determines, and may be defined by, an angular range Θ over which the pencil beam 23 is configured to scan. The FOV may be set to a variable, predetermined value by adjusting the variable, relative displacement 131 in order to effect a change in the position 28 where the irradiating fan beam is received by the disk chopper wheel 1 and intersects cross-sectionally with the radial slit apertures 21. For larger target objects 11 (e.g., taller in the X direction in FIG. 1), a greater angular FOV may be chosen by causing the position 28 of the irradiating fan beam to be closer to the periphery (rim) of the disk chopper wheel 1. On the other hand, for a smaller target object (an object that is shorter in the X direction illustrated in FIG. 1, for example), the position 28 of the radiating fan beam may be chosen to be relatively closer to the center of the disk chopper wheel 1 by effecting the variable, relative displacement 131 of the collimator and source using the translation mechanism 129.

In FIG. 1, the collimator 17 is oriented in the XY plane, and the fan beam plane 20 is parallel to the XZ plane illustrated therein. The disk chopper wheel 1 is oriented in a plane parallel to the XY plane, and the pencil beam 23 scans in the fan beam plane 20, parallel to the XZ plane, as a function of the rotation 24 of the disk chopper wheel 1. The translation mechanism 129 causes the variable relative displacement 131 in a direction that is parallel to the Y direction illustrated. Accordingly, in the system 100, the translation mechanism 129 is configured to effect the variable, relative displacement 131 between the disk chopper wheel 1 and the fan beam plane in a direction (parallel to the Y direction in FIG. 1) that is substantially normal to the fan beam plane 20 (parallel to the XZ plane in FIG. 1).

It will be noted that in the system 100 that the rotation plane (parallel to the XY plane illustrated in FIG. 1) is perpendicular to the fan beam plane 20 (parallel to the XZ plane illustrated in FIG. 1). However, in other embodiments, the rotation plane of the disk chopper wheel is non-perpendicular to the fan beam plane. As described hereinafter, a disk chopper wheel may be oriented with a rotation plane that is substantially non-perpendicular with respect to the fan beam plane. The non-perpendicular arrangements can result in substantially decreased weight of a chopper disk wheel 1 and system 100, even while maintaining a similar degree of radiation blocking or effective thickness of the disk chopper wheel with respect to the fan beam of illuminating radiation.

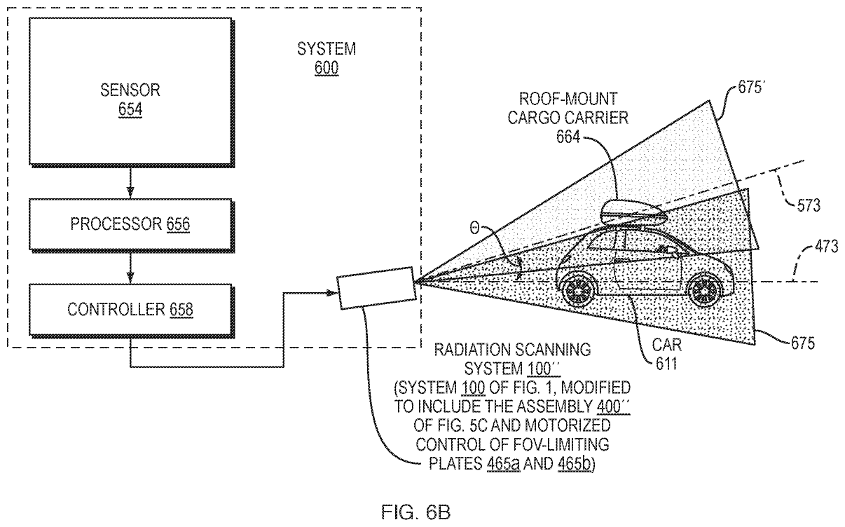

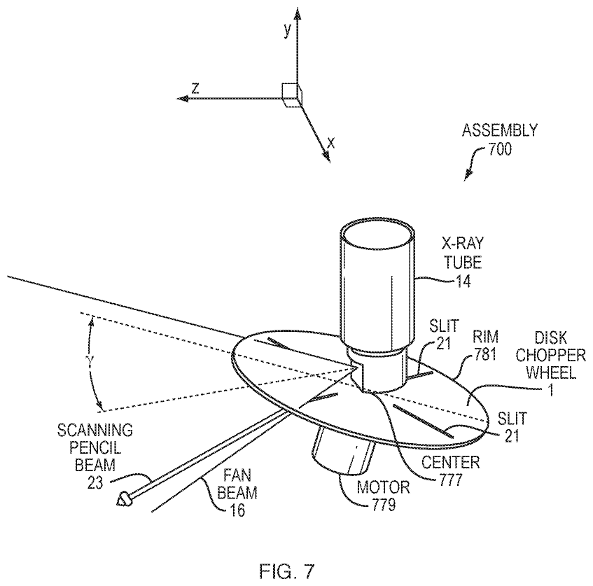

Generally, the translation mechanism may effect the variable, relative displacement between the disk chopper wheel and the fan beam plane with a displacement component (directional component) that is parallel to the fan beam plane and/or a displacement component that is perpendicular to the fan beam plane. Embodiments that effect displacement with at least some displacement component that is parallel to the fan beam plane are particularly advantageous where the rotation plane of the disk chopper wheel is non-perpendicular to the fan beam plane. Non-perpendicular disk chopper wheel embodiments are described hereinafter in connection with FIGS. 7, 16A-16C, and 17A-17C, for example. In general, the translation mechanism may be configured to effect the variable, relative displacement between the disk chopper wheel and the fan beam plane such that the displacement is parallel to the rotation plane of the disk chopper wheel, which may be non-perpendicular to the fan beam plane, as described above.

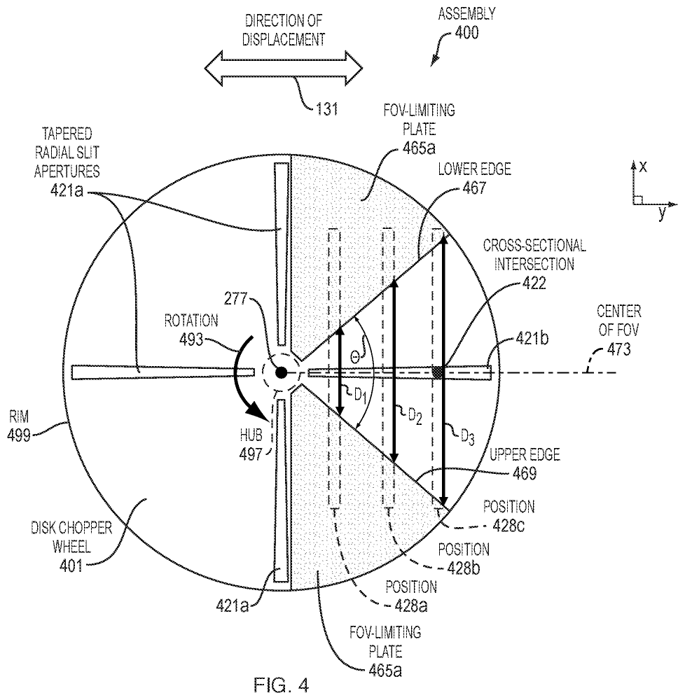

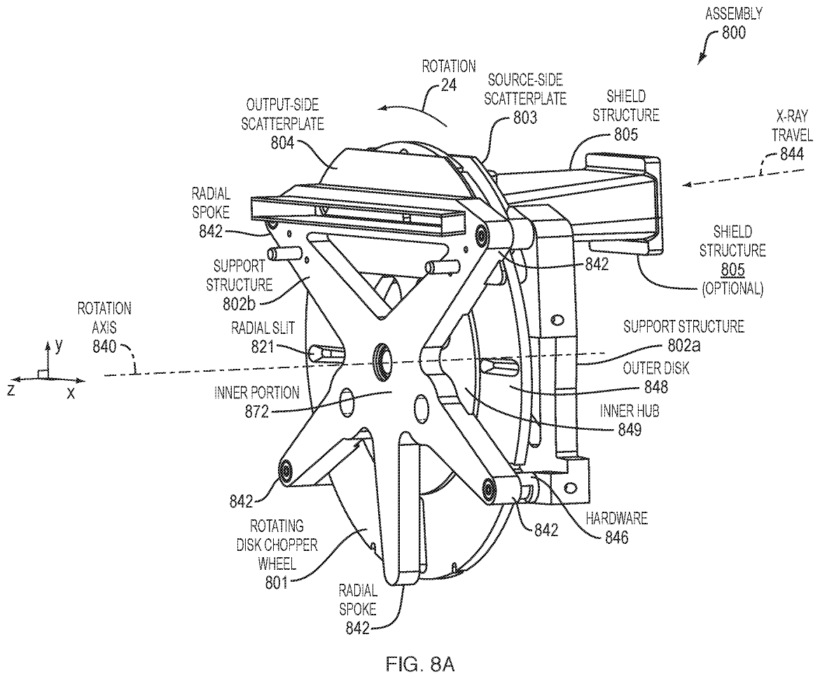

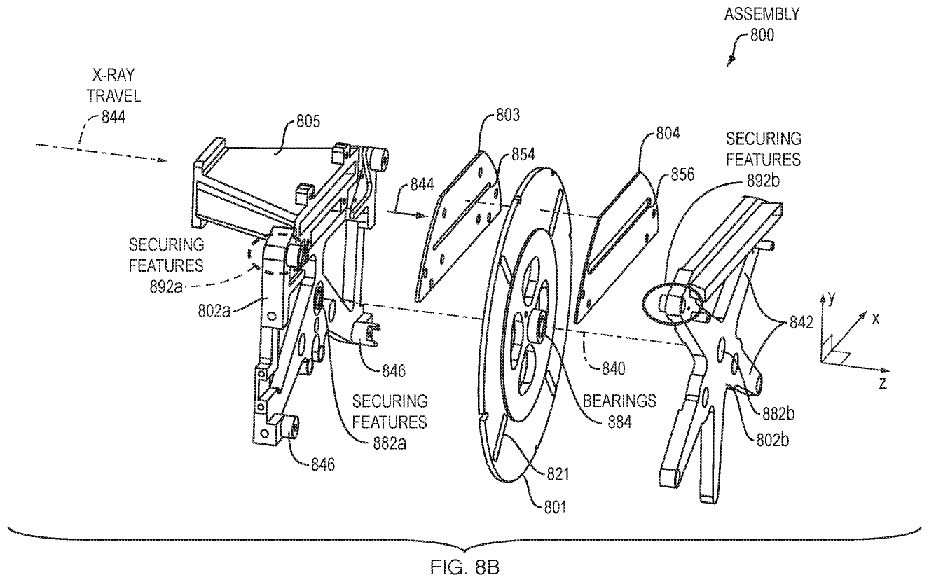

The system 100 may be modified to include a disk chopper wheel assembly with FOV-limiting plates for both adjusting and steering the FOV of the system, as described in connection with FIGS. 4-6A and 19, for example. Alternatively, or in addition, the system 100 may be modified to include a non-perpendicular chopper wheel, as described in connection with FIGS. 7, 16A-16C, and 17A-17C; and/or source-side and output-side scatter plates, as described in connection with FIGS. 8A-8B, 9A-9B, 10-11, 12A-12B, and 13, for example. These modifications can be advantageous for providing enhanced shielding even while limiting or drastically reducing scanning system weight, for example.

FIGS. 2A-2C are illustrations of various translation mechanisms that may be used in the embodiment systems. FIG. 2A is a perspective-view illustration of a translation mechanism 229a on which the disk chopper wheel 1 is mounted to effect the variable relative displacement 131. The disk chopper wheel 1 is configured to rotate about a rotation axis 277 that is parallel to the z axis illustrated in FIG. 2A and is perpendicular (normal) to a plane of rotation of the disk chopper wheel 1, which is a plane parallel to the XY plane illustrated in FIG. 2A. The translation mechanism 229a includes a handle 237 connected to a lead screw 235 that extends through the translation mechanism 229a. As the handle 237 is turned manually, the translation mechanism 229a is caused to move in the direction of variable, relative displacement 131, which is parallel to the Y direction illustrated in FIG. 2A. This, then effects the continuous variation 133 of the position 28 of the irradiating fan beam on the disk chopper wheel, as illustrated in FIG. 1. Thus, the translation mechanism 229a is an example of a manual translation mechanism with a manual actuator (the handle 237 acting on the lead screw 235).

Because the handle 237 and lead screw 235 can cause the variable, relative displacement 131 in smooth increments, the fan beam position 28 at which the disk chopper wheel is configured to receive the irradiating fan beam 16 is also smoothly variable. In this manner, the continuous variation 133 in the position 128 is infinitely continuous (the position 28 of the irradiating fan beam 16 may intersect a given radial slit aperture 21 in an infinite number of specific positions, for smooth variation of adjustability of the scanning FOV for the system.

FIG. 2B is a perspective-view illustration of a translation mechanism 229b having a top section 239 and a bottom section 241. The translation mechanism 229b is an example of an electromechanical actuator because it includes a motor 245 that turns the lead screw 235 to move the top section 239 relative to the bottom section 241. The top section 239 includes an extension (or tongue) 240 that fits inside a slot 243 in the bottom section 241. As the motor 245 turns in operation, the top section 239 slides, guided by the extension 240, within the slot 243 for smooth. variable, relative displacement 131. Accordingly, translation mechanisms in embodiment systems may include slide mechanisms, such as are provided by the combination of the extension 240 and slot 243, for example. This motor 245 may include a stepper motor or any other motorized motion controller, for example. While not shown in FIG. 2B, the source may be mounted on the top section 239, as in the system 100 of FIG. 1, or the chopper wheel may be mounted on the top section 239, as illustrated in FIG. 2A, for example.

FIG. 2C is a side-view illustration of a translation mechanism 229c that may be used in embodiment systems. The translation mechanism 229c differs from the translation mechanisms 229a and 229b in that it causes the variable, relative displacement 131 discreetly, such that only certain translation positions are available. A bottom section 247 of the translation mechanism 229c includes rods 251 fastened thereto, spaced regularly at particular intervals. A top section 249 includes grooves 253 that are configured to fit over the rods 251, allowing flat portions of the top section 249 to mate with the top surface of the bottom section 247 smoothly. In order to move the top section 249 to cause the variable, relative displacement 131, handles 257 are provided. One or more people can lift the top section 249 by the handles 257 up and to the right or left with a motion 259 in order to set the top section 249 onto a different set of the rods 251, thus effecting the variable relative displacement 131. A bracket 255 is provided to mount the disk chopper wheel 1 to the top section 249. Using the translation mechanism 229c, which is also designed to be a manual translation mechanism, only certain positions 28 of the irradiating fan beam on the disk chopper wheel 1 are accessible. Nonetheless, all of the translation mechanisms 229a-229c illustrated in FIGS. 2A-2C, respectively, have the advantage that the radiating fan beam 16 may intercept a given one of the radial slit apertures 21 at multiple cross-sectional intersection positions for scanning using correspondingly multiple, respective FOVs.

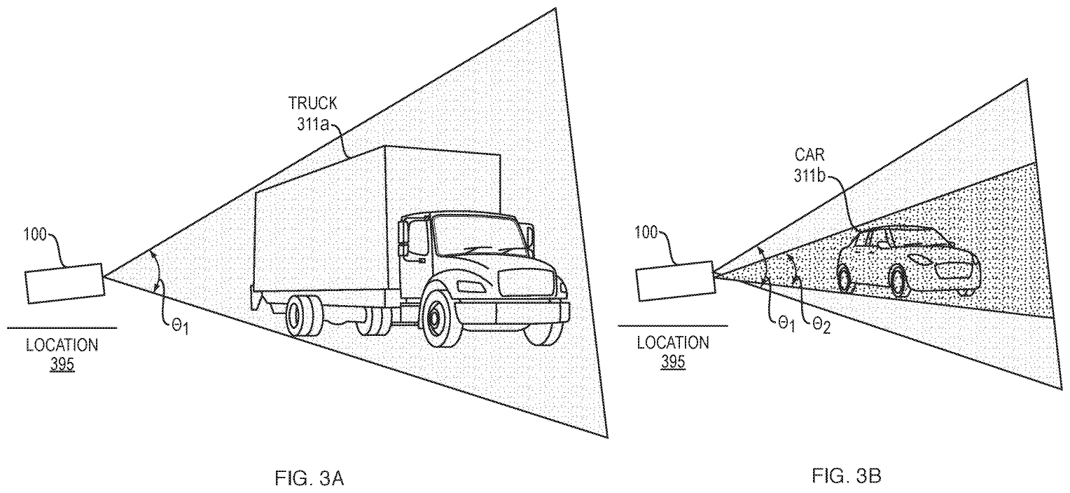

FIGS. 3A-3B are illustrations of a vehicle scanning environment in which the system 100 of FIG. 1 may be used with great advantage. FIGS. 3A-3B illustrate the system 100 being used at a location 395, which may be a location of a stationary x-ray inspection portal or a location of a mobile, truck-mounted inspection system (not illustrated in FIGS. 3A-3B) such as the truck-mounted system illustrated in FIG. 14.

In FIG. 3A, the system 100 is being used to scan a truck 311a, for which a FOV Θ₁ is required. In contrast, in FIG. 3B, the system 100 is being used to scan a car 311b, for which only a smaller FOV Θ₂ is required. Advantageously, because of the variable, relative displacement 131 and continuous variation 133 of the position 28 of the fan beam on the disk chopper wheel (illustrated in FIG.1), the two different FOVs may be provided for scanning the two different vehicles with the different FOV requirements. Similar considerations are true for any scanning environment for any target objects to be scanned, including scanning the luggage target objects, as illustrated in FIG. 1. The FOV may be set dynamically, by adjusting the variable, relative displacement 131 between scans of target objects of different sizes, for example. The adjustment and corresponding different FOVs are described further in relation to FIGS. 4-6A, 15A-15C, 16A-16C, and 17A-17C, for example.

### Varying the Field of View

FIG. 4 illustrates in greater detail how FOV may be varied in embodiment systems by changing the position at which the irradiating fan beam is received at the disk chopper wheel. FIG. 4 illustrates a disk chopper wheel 401 that is similar to the disk chopper wheel 1 of FIG. 1. The wheel 401 is part of a disk chopper wheel assembly 400. In the example disk chopper wheel 401, four tapered, radial slit apertures 421a and 421b are defined in the disk chopper wheel, but it should be understood that any number of slit apertures can be used. The number of slit apertures may depend on the maximum size of the FOV that is required and the distance L of the x-ray source to the disk. The slit apertures 421a and 421b in FIG. 4 are longer than typical prior-art slit apertures, extending from close to a central disk chopper wheel hub 497 to close to an outer periphery (rim) 499 of the disk. These longer slit apertures have the advantage of allowing a greater variation in the FOV due to a greater number of positions at which the fan beam may be set to intersect cross-sectionally with any given slit aperature. The tapering of the radial slit aperatures has the advantage of more uniform x-ray flux in a scanning pencil beam that may be formed using the disk chopper wheel 401.

A collimated fan beam of radiation from an x-ray source can be incident at any of a number of positions at the right side of the disk chopper wheel 401, as denoted by the positions 428a-c at which the disk chopper wheel 401 may receive the fan beam, depending on the variable, relative displacement 131 between the disk chopper wheel 401 and the fan beam plane in which the fan beam is oriented. The disk chopper wheel 401 can be translated (displaced) left or right relative to the x-ray source as shown by variable, relative displacement arrow 131, so that the fan beam irradiation (denoted by the vertical white dashed rectangle positions 428a-c) incident on the source side of the disk can be moved between position 428a (close to the wheel hub) and position 428c (close to the wheel periphery). Note that any intermediate position can be selected, one of which is denoted 428b.

As the disk chopper wheel 401 rotates, as indicated by arrow 493, x-rays can pass through the opaque disk chopper wheel only in the area defined by the cross-sectional intersection of the irradiated slit (radial slit aperture 421b at the instant of the illustration of FIG. 4) with the region of irradiation of the incident fan beam on the disk 428a, 428b, or 428c. An example cross-section intersection 422 is illustrated in FIG. 4 between the fan beam position 428c and the radial slit aperture 421b.

The particular disk chopper wheel 401 in FIG. 4 also includes two x-ray opaque plates 465a and 465b, which are also referred to herein as “FOV-limiting plates.” In general, “FOV-limiting plates” described herein are positioned relative to the disk chopper wheel and provide, by one or more plates, two radial edges that extend radially from an axis of rotation of the disk chopper wheel, and also prevent dual pencil beams from forming during a scan. The particular FOV-limiting plates 465a and 465b are positioned so that the x-rays in the fan beam incident on the plates are blocked by being absorbed and cannot pass through the illuminated slit aperture 421b. As the illuminated slit aperture 421b crosses an upper radial edge 469 of FOV-limiting plate 465b, the output beam enters the FOV, and a new line of image data acquisition begins. The end of the acquisition of the image line occurs when illuminated slit aperture 421b crosses a lower edge 467 of the upper FOV-limiting plate 465a, and the output beam exits the FOV.

The object being imaged may be moved laterally through the output beam, and the next line of image acquisition occurs when the next slit aperture (421a in the illustration of FIG. 4) crosses the upper edge 469. Being positioned relative to the disk chopper wheel may include the plates 465a and 465b being positioned between the source and the disk, being placed on the far side of the disk from the source, between the disk chopper wheel and target, or in other locations, such as being mounted near the disk chopper wheel, or even in a location adjacent to a collimator or source such as the attenuating plate collimator or source 14 illustrated in FIG. 1, for example. The plates 465a and 465b may be adjustably attached to a disk chopper wheel assembly for selectable, rotatable position. The FOV-limiting plates, like disk chopper wheel, may be formed preferably of lead, tungsten, or another material of high atomic number (high Z)

A FOV (or angular range) of a sweeping output pencil beam of the system can be calculated from FOV=2 atan[D/(2L)], where D is the length of the illuminated strip on the disk that is not absorbed by opaque plates 465a and 465b, and where L is a distance from a focal spot of the radiation source to a center of the illuminated strip on the disk. (While not illustrated, in the example of FIG. 1, L may be measured along an axis parallel to the Z axis from a focal point in the source 14 to the position 28 where the fan beam 16 intersects the disk chopper wheel 1.) Still referring to FIG. 4, for example, when the fan beam is incident on the disk chopper wheel 401 at the position 428a, nearest the hub 497, if D₁32 2 inches and L=4 inches, then a first FOV, FOV₁=28.1°, results. When the disk chopper wheel is translated to the left and the fan beam is incident on the disk chopper wheel at position 428c nearest the periphery, then if D₃=7 inches, a third FOV, FOV₃=82.4°, results. A second, intermediate FOV, FOV₂, results from intermediate positions. An imaging system formed with the assembly 400, therefore, may have an example, variable FOV between about 28° and about 82°, with the FOV being selectable by translating the disk chopper wheel relative to the incident illuminating fan beam through a certain distance. It should be understood that this same variable, selectable FOV may be obtained by other types of variable, relative displacement between the disk chopper wheel and the fan beam plane, such as those illustrated in FIGS. 1, 16A-16C, and 17A-17C, for example. A center 473 of the FOV is also illustrated in FIG. 4, and each of the FOVs in FIG. 4 is angularly symmetric about the center 473.

The relative translation (displacement) between the disk chopper wheel and the incident illuminating fan beam can be accomplished by electronic means, using, for example, a stepper motor or some other kind of actuator. This allows the FOV to be varied in near real-time. For example, if a truck needs to be scanned as illustrated in FIG. 3A, a larger FOV can be selected. Then, if a next vehicle to be scanned is a car automobile, a smaller FOV may be selected, as illustrated in FIG. 3B, for example. Alternatively, the relative displacement between the disk chopper wheel and the incident fan beam can be set at the factory, allowing a single x-ray source assembly to be used in a variety of different imaging systems that require different magnitudes of FOV of the output beam.

### Steering the Field of View

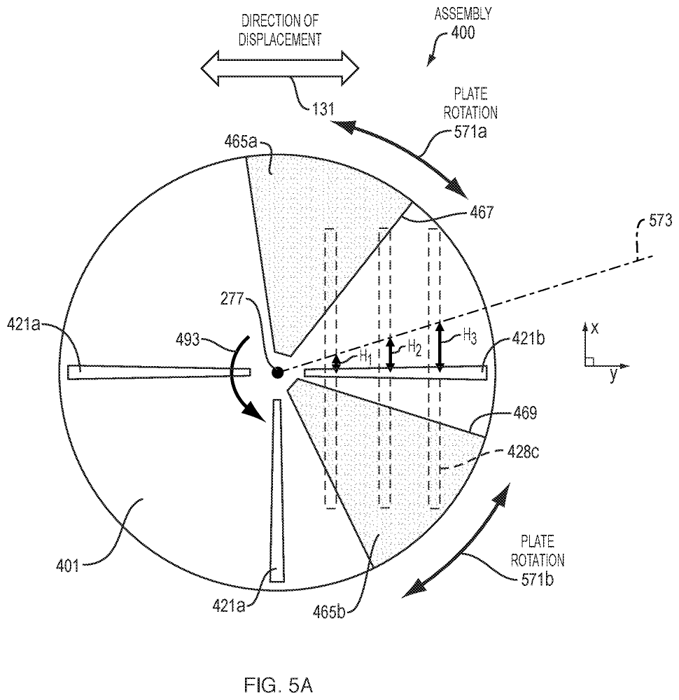

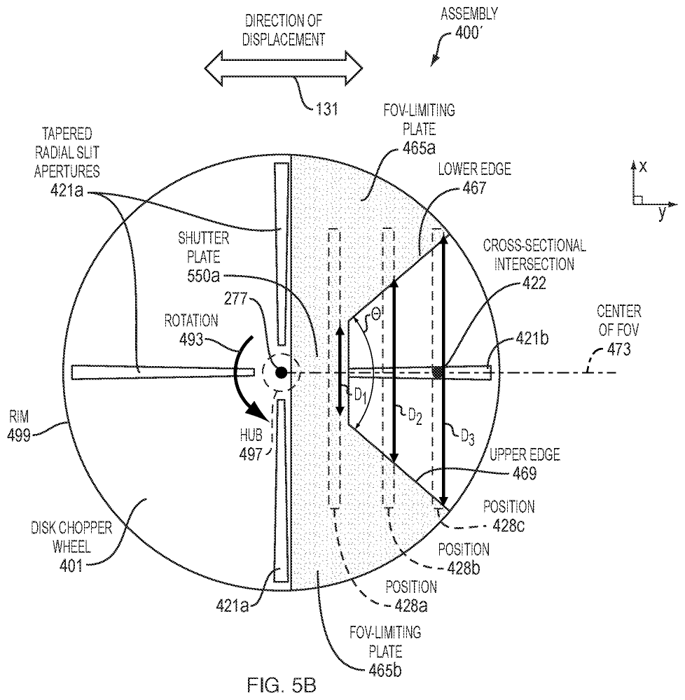

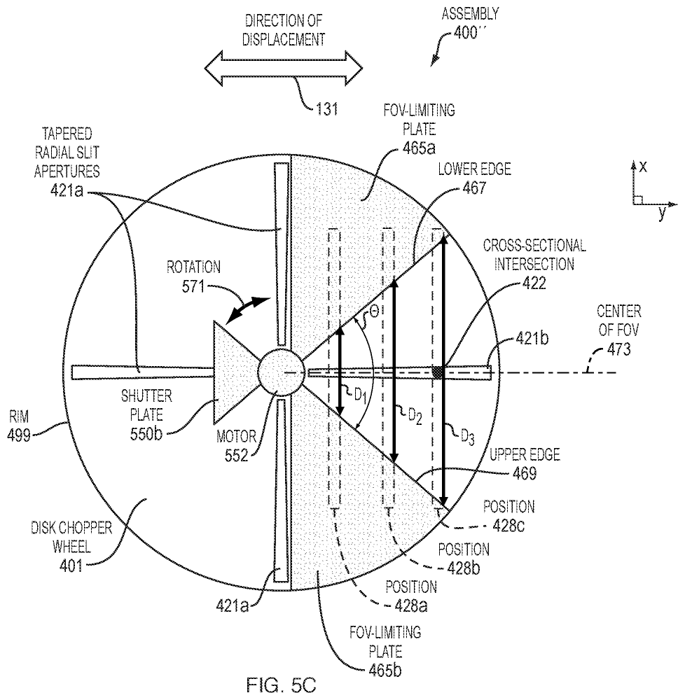

FIG. 5A illustrates how the assembly 400 (also illustrated in FIG. 4) can be adjusted to steer a central axis 573 of the FOV so that objects at different angular locations or heights can be imaged. Advantageously, this adjustment of the central axis 573 is in addition to varying the FOV of the imaging system by translating the disk chopper wheel relative to the illuminating fan beam. This steering of the central axis 573 can be achieved by rotating the x-ray opaque plates 465a and 465b. The rotation may be about the central rotation axis 277 of the disk chopper wheel (the center of the hub 497 in FIG. 4, for example). The FOV-limiting plate 465a can be rotated in either direction about the rotation axis of the disk chopper wheel 401, as indicated by an arrow 571a. Similarly, the FOV-limiting plate 465b can be independently rotated in either direction, as indicated by arrow 571b. In one alternative embodiment, the plates are attached to a single assembly and fixed with respect to each other so that they may be rotatably adjusted together while maintaining a fixed relative angular orientation with respect to one another.

As an example, if opaque plates 465a and 465b are both rotated together anticlockwise about the rotation axis 277 of the disk chopper wheel 401, then the position of illuminated slit 421b corresponding to the beam lying on the central axis of the FOV is now indicated by the dashed line 573, which no longer lies in the horizontal plane, as the center of FOV 473 in FIG. 4 does. In FIG. 5A, if the disk is being illuminated by the fan beam in region (position) 428c near the disk periphery, then the region at which x-rays are able to pass through the disk is now a height H₃ above the horizontal plane. The angular tilt of the FOV from the horizontal plane can be calculated from Φ=atan[H/L], where L is the distance from the focal spot of the radiation source to the center of the illuminated strip 428c on the disk. For example, if H₃=1 inch, then Φ₃=14°.

FIG. 5B illustrates an alternative assembly 400′ that is similar to the assembly 400 of FIGS. 4-5, with the exception that the assembly 400′ includes a shutter plate 550a. In the assembly 400′, the shutter plate 550a forms part of the FOV-limiting plates 465a-465b, such that the shutter plate 550a and FOV-limiting plates form a solid, continuous unit. For a system such as the system 100 in FIG. 1, a warmup period can be on the order of one hour to allow an x-ray tube, for example, to be prepared for use during scanning. During this warm-up time, and during other standby times, it is advantageous to ensure that x-rays or other penetrating radiation emitted from the source are blocked by a chopper wheel assembly. In the embodiment assembly 400′, during these warm-up or standby periods, the displacement 131 is set such that the fan beam is received at the position 428a, closest to the hub of the disk chopper wheel 401. In this position, the fan beam is blocked by the shutter plate 550a, ensuring safety during the warm-up for the source.

In the assembly 400′, the FOV-limiting plates 465a and 465b, together with the shutter plate 550a, may be controlled by a single manual adjustment, such as a set screw, or by motorized control since they rotate together about the center axis of rotation 277. In other embodiments, however, the shutter plate 550a may not be mechanically coupled to the FOV limiting plates and may freely rotate about the axis 277 independent of the FOV-limiting plates for 465a-465b. Furthermore, it should be noted that the shutter plate 550a may have other shapes, such as covering all areas of the disk chopper wheel 401 where the fan beam is not intended to intersect cross-sectionally with the radial slit apertures during scanning. In the assembly 400′, the position 428a is blocked for safe warm-up and other standby periods, but the positions 428b, 428c, and other intermediate positions are available for selectable FOV for various scans.

FIG. 5C illustrates a chopper a disk chopper wheel assembly 400″ that is similar to the assembly 400′ in FIG. 5B, except that the assembly 400″ includes a shutter plate 550b that rotates independently from the FOV-limiting plates 465a-465b. The shutter plate 550b may be rotated to cover the position 428a of the fan beam during standby and warm-up periods. The shutter plate 550b may be rotated to the position shown, with a rotation 571, for example, during scanning periods. As described in connection with FIG. 5B, the shutter plate 550b may take any form or shape, including covering a greater portion of the chopper wheel. Shutter plates in other embodiments need not have radial edges such as those illustrated for the shutter plate 550b.

The assembly 400″ further includes a motor 552 that is configured to control the rotational position of the shutter plate 550b. The motor 552 may be a stepper motor or another type of motor, for example. A similar motor may be used to control the FOV-limiting plates 465a-465b either together, while they remain fixedly oriented with respect to each other, or independently for further adjusting FOV of the system.

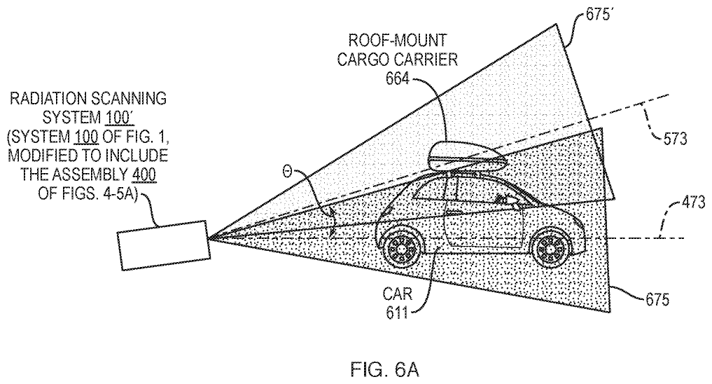

FIG. 6A illustrates how the angular tilt of the FOV provided by the assembly 400 of FIGS. 4 and 5A-5C may assist in scanning applications. FIG. 6A illustrates a car 611 having a roof-mount cargo carrier 664. It can be advantageous to scan the carrier 664 separately for a separate inspection with a FOV that is tilted upward from the horizonal in order to capture the carrier 664. In this example, the horizontally-oriented FOV is optimal for scanning the main body of the small automobile 611, whereas the upward-tilted FOV is more useful for scanning the roof-mounted cargo. In order to perform these scans, the system 100 of FIG. 1 is modified to include the disk chopper wheel assembly 400 of FIGS. 4 and 5A to form a system 100′ having a steerable FOV.

In order to scan the main body of the car 611, the FOV-limiting plates 465a and 465b are adjusted as illustrated in FIG. 4, with the center 473 of the FOV 675 pointing along the horizontal direction. However, for scanning the roof-mount cargo carrier 664, FOV-limiting plates 465a and 465b are adjusted as illustrated in FIG. 5A, and a resulting, tilted FOV 675′ is now tilted upward with a new central FOV axis 573 at an angle of Φ=14° relative to the horizontal.

The rotation of the FOV-limiting plates 465a and 465b can be carried out manually, releasing and re-setting the position of the plates using set screws, for example. However, in other embodiments, electronics and electromechanical means such as a stepper motor or other motion management and controls may be used. The FOV settings for different scans may be set via a computer that commands the motion control components to move the FOV-limiting plates appropriately. This can allow the beam to be steered in near real-time. Alternatively, the position of the opaque plates can be set manually at the factory, allowing a single x-ray source assembly to be used in a variety of different imaging systems that require different angular ranges over which the output beam is scanned.

As already described, the rotation plane of the disk chopper wheel may be non-perpendicular to the fan beam plane in various embodiment systems. As described hereinafter, a disk chopper wheel may be oriented with a rotation plane that is substantially non-perpendicular with respect to the fan beam plane. The non-perpendicular arrangements can result in substantially decreased weight of a chopper disk wheel 1 and system 100, even while maintaining a similar degree of radiation blocking or effective thickness of the disk chopper wheel.

FIG. 6B is a schematic diagram illustrating a system 600 that incorporates the radiation scanning system a radiation scanning system 100″. The system 100″ includes the system 100 of FIG. 1, modified to include the assembly 400″ of FIG. 5C, as well as motorized control of FOV-limiting plates 465a and 465b of FIG. 5C. Motorized control of the FOV-limiting plates is described in connection with FIG. 5C, for example.

The system 600 includes components to sense target object characteristics automatically and to adjust FOV size and center axis automatically, accordingly. The system 600 includes a sensor 654. The sensor can be a camera, for example, that is directed to acquire images of vehicles such as the car 611 passing an inspection portal at which the system 100″ is located, or passing a mobile scanning platform in which the system 100″ is located, such as the mobile platform of FIG. 14. Alternatively, the sensor 654 may include a lidar system or other a later system, a laser-based system, an acoustic system, or other sensor such as a weight sensor installed in the ground under a vehicle scanning portal. The sensor is configured to determine size, height, shape, weight, or other characteristics of vehicles or other target objects to be scanned.

The sensor 654 provides input to a processor 656 in the system 600. The processor 656 uses data from the sensor 654 to determine settings for the FOV-limiting plates 465a and 465b and for the translation mechanism 129 illustrated in FIG. 1. For example, if the processor 656 determines from the sensor input that a vehicle to be scanned is small, such as the car 311b illustrated in FIG. 3B, then the processor 656 may determine that a smaller FOV Θ2, as illustrated in FIG. 3B, should be used for the scan. Alternatively, the processor server the processor 656 may determine based on sensor inputs that the vehicle is large, such as the truck 311a illustrated in FIG. 3A, and a decision may be made to use the larger FOV Θ1 illustrated in FIG. 3A, for example.

Furthermore, the processor 656 can determine, based on sensor input, where to steer a center axis of the field of view of the system, such as the center axes 473 and 573 illustrated in FIG. 6B, for example. The processor may determine that two different scans should be performed, one with the center axis 473, and another for the center axis 573, based on a determination that the car 611 in FIG. 6B includes the cargo carrier 664, for example. Once the processor 656 determines the settings for field of view size and direction, the processor may send directions to a controller 658. The controller 658 drives one or more motors, similar to the motor 552 illustrated in FIG. 5C, to control the FOV-limiting plates 465a and 465b illustrated in FIG. 5C, which form part of the scanning system 100″. In this manner, the FOV-limiting plates may be adjusted for FOV size and direction, as previously described. Furthermore, the controller 658 causes the translation mechanism 129 illustrated in FIG. 1 to change the variable, relative displacement 131 appropriately for the FOV chosen. As described previously, the translation mechanism 129 may be modified to translate to displace the disk chopper wheel assembly instead of the source in order to obtain the relative displacement between them.

Using the system 600, manual adjustments of embodiment scanning systems may be limited, or completely eliminated, in order to increase throughput of target objects, such as the number of cars that can be scanned at an inspection portal per unit time.

### Reducing the Size and Weight of Embodiment Radiation Scanning Systems

Embodiments described herein can be advantageously combined with either one or both, of two pending patent applications to reduce the size and weight of the imaging system further. One of these applications, Application PCT/US2015/061952 by Rothschild, describes a system with a tilted disk chopper wheel, which orients the disk chopper wheel so that the incident illuminating fan beam strikes the disk surface at a large oblique angle. This means that the thickness of the disk can be greatly reduced, resulting in weight and cost savings. The thickness of the disk can be reduced by the factor F=1/(sin γ), where γ is the angle between the plane of rotation of the disk and the fan beam plane (a factor F=1/(cos α), where where α=90°-γ is the angle between the normal to the face (plane of rotation) of the disk and the plane containing the incident fan beam). For example, if an oblique angle of incidence α is 70°, the thickness of the disk chopper wheel can be reduced by a factor of 3. For a 225 kV source, this corresponds to a reduction from about a 12 mm thick tungsten disk to only about 4 mm thick tungsten. Note that nothing in the current embodiments described herein precludes incorporating the tilted design of Application PCT/US2015/061952 by Rothschild, which is hereby incorporated herein by reference in its entirety.

FIG. 7 is an illustration of a disk chopper wheel assembly 700 that may be incorporated advantageously into embodiment systems in order to decrease the weight of a chopper wheel while maintaining effective thickness. In the assembly 700, the x-ray tube source 14 outputs the fan beam 16, with the fan beam that is in a fan beam plane at an angle γ with respect to the rotation plane of the disk chopper wheel 1, which has a rim periphery 781. The x-ray tube 14 is oriented with an axis in the Y direction. The fan beam 16 is oriented in the X-Z plane, such that the fan beam plane is the X-Z plane. The plane of rotation of the disk chopper wheel lies at an oblique, non-perpendicular angle y with respect to the X-Z plane The scanning pencil beam 23 also is scanned in the X-Z plane, i.e., the fan beam plane, as the disk chopper wheel rotates. The disk chopper wheel 1 has the radial slit apertures 21 oriented to extend radially toward the rim 781 and toward the center 777. The disk chopper wheel 1 is rotated by means of a motor 779.

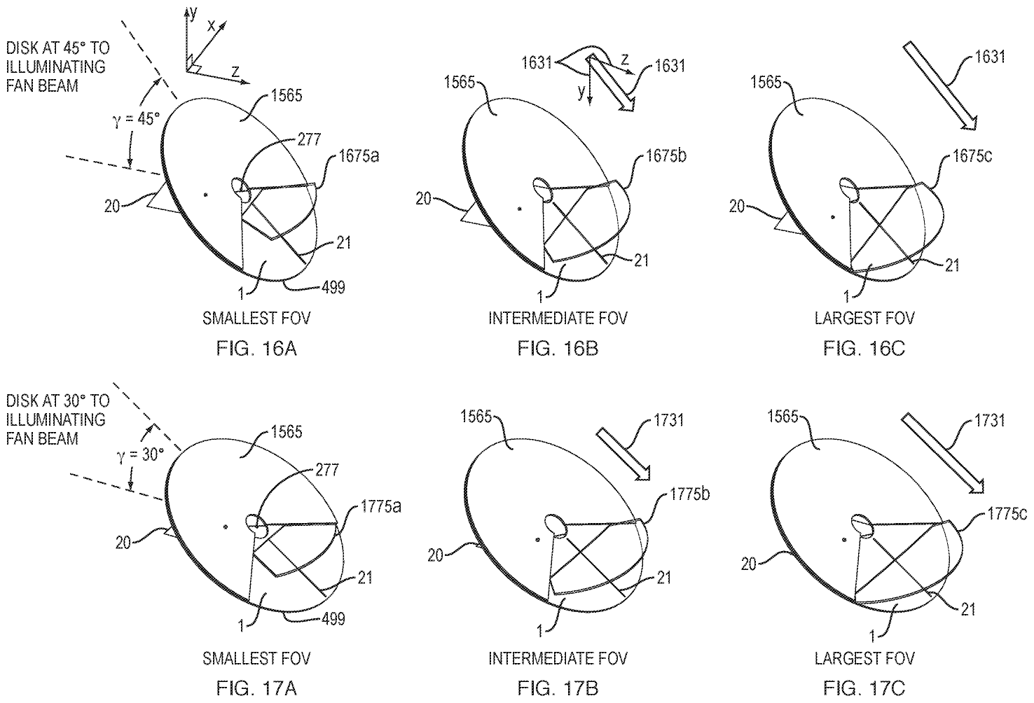

The disk chopper wheel 1 is not oriented in either the X-Z plane or the X-Y plane, but, rather, in a disk chopper wheel plane (plane of rotation of the disk chopper wheel) that is at an angle γ with respect to the beam plane (X-Z plane) of the fan beam 16. The disk chopper wheel plane can also be referred to as a plane of rotation (or rotational plane) of the disk chopper wheel 1, because the disk remains parallel to this plane as it rotates. The disk plane can be parallel to the X axis, even while remaining non-parallel to the X-Z plane. By positioning the plane of the rotating disk at an acute (substantially non-perpendicular) angle γ with respect to the plane of the fan beam, the actual thickness of the disk can be reduced by a factor F=1/sin (γ) while keeping the disk's effective thickness the same. As used herein, “substantially non-perpendicular” indicates that the angle γ is small enough to increase effective thickness significantly, such as increasing effective thickness by more than 25%, more than 50%, more than 100% (an effective thickness multiplier of 2), more than 200%, or more than 400%. This can result in a dramatic decrease in weight of a disk chopper wheel in embodiment systems, decreasing cost and facilitating placing two or more scanning systems in a mobile scanning platform such as the truck illustrated in FIG. 14. Non-perpendicular arrangements are further illustrated in FIGS. 16A-16C and 17A-17C, for example.

Additional weight savings can be achieved by further combining the current invention with the teachings of a second of the applications referenced hereinabove, namely U.S. patent application Ser. No. 15/946,425, by Rothschild, filed on Apr. 5, 2018, which is hereby incorporated by reference herein in its entirety. This application teaches an open disk chopper wheel assembly that does not require extensive radiation shielding completely enclosing the disk. A scatter plate on the source-side of the disk chopper wheel where the fan beam is incident uses a relatively small scatter plate to contain the leakage radiation scattered from the disk surface. Since some embodiments described herein rely on variable, relative displacement between the disk chopper wheel and the illuminating fan beam of incident radiation in order to vary the FOV, the scatter plates taught in U.S. patent application Ser. No. 15/946,425 can greatly reduce the size and weight required to shield all system components, even while still allowing the full range of required relative motion.

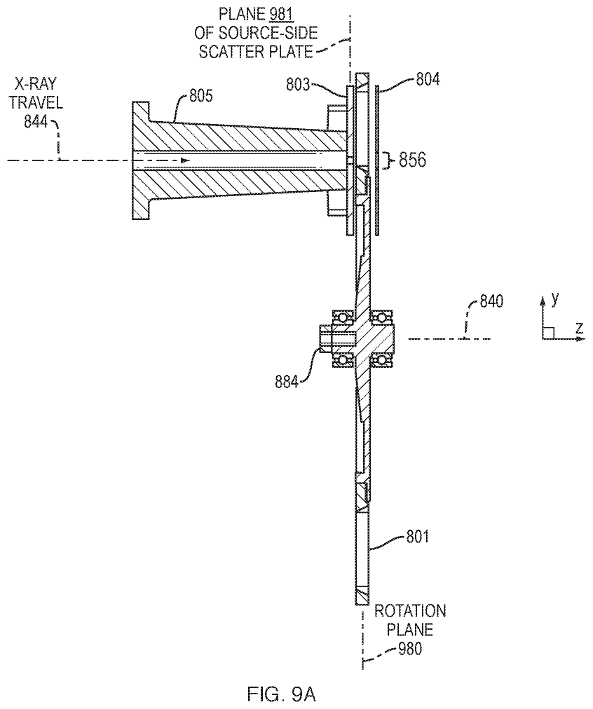

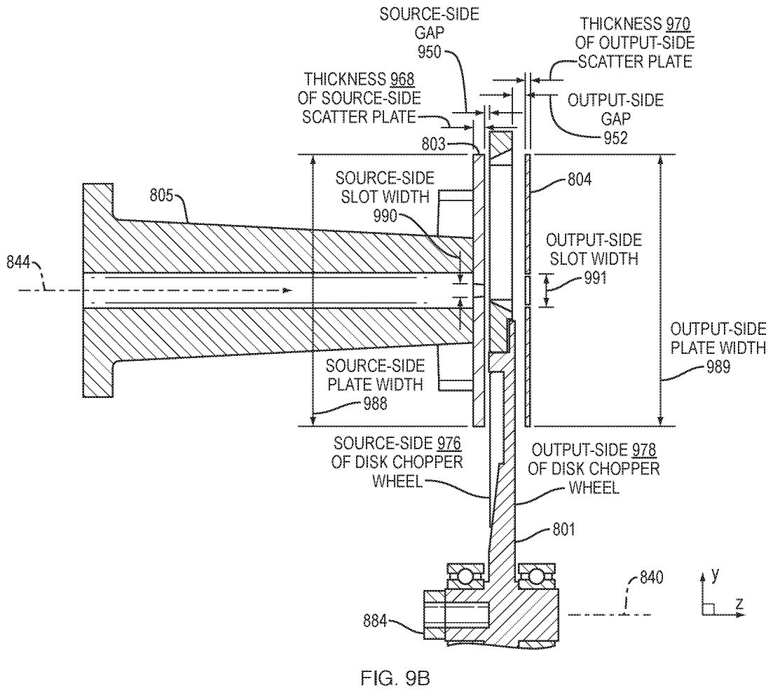

FIG. 8A is a perspective-view illustration of a disk chopper wheel assembly 800 that includes scatter plates that may be used in embodiment systems to reduce system weight. The assembly 800 includes a disk chopper wheel 801 that is configured to rotate about a rotation axis 840. In the illustration of FIG. 8A, the rotation axis 840 coincides with the Z axis for the coordinate system that is shown. The rotation axis 840 is perpendicular to a rotation plane of the disk chopper wheel 801. The rotation plane is parallel to the XY plane that is shown in FIG. 8A. The rotation plane is further illustrated in FIG. 9A. The disk chopper wheel 801 has a solid cross-sectional area in the rotation plane that is illustrated in FIG. 11. The wheel 801 is configured to absorb x-ray radiation traveling in a direction 844 from an x-ray source (not shown in FIG. 8A) that is received at a source side of the chopper wheel (the side where x-rays are first incident, traveling along the direction 844). The disk chopper wheel 801 defines radial slit openings 821 around the wheel, and these radial slit openings are configured to pass x-ray radiation from the source side of the wheel to an output side of the disk chopper wheel. The source and output sides are further illustrated in FIG. 9B.

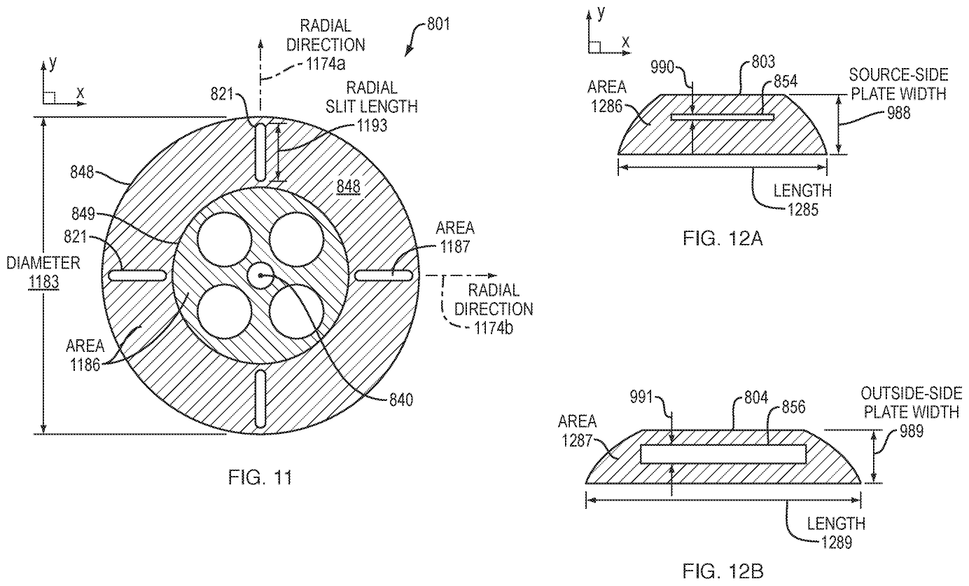

The assembly 800 further includes a source-side scatter plate 803 that has a solid cross-sectional area in a plane parallel to the rotation plane of the wheel. This cross-sectional area is illustrated in FIG. 12A. The source-side scatter plate 803 is configured to absorb x-ray radiation, and it defines an open slot therein that is configured to pass x-ray radiation. The open slot is further illustrated and described in connection with FIGS. 9A-9B and 12A, for example. Advantageously, the solid cross-sectional area of the source-side scatter plate is substantially smaller than the solid cross-sectional area of the disk chopper wheel, providing for operation of the assembly with significantly reduced weight, even while maintaining x-ray confinement similar to that of existing disk chopper wheel assemblies that include a full shielding enclosure surrounding an entire disk chopper wheel.

The source-side scatter plate 803 is secured by a support structure 802a-b that secures the source-side scatter plate substantially parallel to the rotation plane of the disk chopper wheel with a source-side gap between the source-side scatter plate and the source side of the disk chopper wheel, as further illustrated in FIGS. 9A-9B, for example. While an output-side scatter plate is generally optional, the assembly 800 does include an output-side scatter plate 804 that is secured by the support structure 802a-b to be substantially parallel to the rotation plane of the disk chopper wheel, similar to the source-side scatter plate 803. The support structure maintains an output-side gap between the output side of the scatter plate and the disk chopper wheel, as illustrated in FIG. 9B. In alternative assemblies not illustrated, the source-side and output-side scatter plates may form a single solid piece, the two scatter plates of which are connected by a bridge over the top of the disk chopper wheel 801 in FIG. 8A. Further in alternative embodiments, such a bridge structure may also be formed of a high-Z material to enhance shielding.

The output-side scatter plate 804 has a solid cross-sectional area in a plane parallel to the rotation plane of the disk chopper wheel, as illustrated in FIG. 12B. The output-side scatter plate is configured to absorb x-ray radiation, yet it also defines an open slot therein (illustrated in FIG. 12B) that is configured to pass x-ray radiation that emanates through the source-side scatter plate 803 and slits 821 in the chopper wheel. Advantageously, the solid cross-sectional area of the output-side scatter plate 804, like that of the input source-side scatter plate, is substantially smaller than the solid cross-sectional area of the disk, further providing for a lightweight assembly.

In the assembly 800, the support structure 802a-b is further configured to secure the disk chopper wheel 801 at the rotation axis 840. Advantageously, therefore, the support structure 802a-b performs both the functions of securing the chopper wheel and the functions of securing the source-side and output-side scatter plates 803 and 804, respectively. Further, in the embodiment assembly 800, it will be noted that the support structure includes the two portions 802a and 802b on the source side and output side of the chopper wheel, respectively. This provides a particularly robust and stable configuration that performs many needed support functions. However, in other assemblies, a support structure may be one-sided, and the chopper wheel and support structure may be secured and mounted separately, while still being secured with the source-side scatter plate being substantially parallel to the chopper wheel and having the appropriate gap between the source-side scatter plate and the source side of the chopper wheel.

Further in the embodiment assembly 800 in FIG. 8A, the support structure 802a-802b includes an inner portion 872 that is configured to secure the disk chopper wheel 801 at the rotation axis 840 thereof, and the support structure 802b further includes radial spokes 842 that extend outward from the inner portion 872 and are configured to secure both the source-side scatter plate 803 and output-side scatter plate 804 with the appropriate alignment and gap with respect to the chopper wheel. The support structure 802a-b does this by means of hardware 846 that secures the two sides of the support structure 802a and 802b together while simultaneously securing the chopper wheel 801, as further illustrated in the exploded-view drawing of the assembly in FIG. 8B. Accordingly, the source-side portion 802a and output side portion 802b of the support structure are configured to be connected together and to secure the disk chopper wheel between the two portions of the support structure.

The support structure 802a-b is formed of aluminum, advantageously, for lighter weight. In other embodiments, other materials may be used. Nonetheless, aluminum may be used advantageously because of low cost, sufficient rigidity and strength, and because the source-side and output-side scatter plates provide the desired shielding, while the support structure need not be relied upon for x-ray shielding.

The assembly 800 further includes an optional shield structure 805 that is configured to enclose the x-ray radiation in a region of travel between the x-ray source (e.g., x-ray tube, not shown in FIG. 8A) and the source-side scatter plate 803. The shield structure 805 may be formed of a high-Z material, for example, such as tungsten, lead, iron, or another high-Z material having sufficient thickness to prevent incident or scattered x-rays from being emitted outside of the device. The particular function and features of the shield structure 805 are further illustrated in FIGS. 8B, 9A-9B, 10, and 13, for example.

FIG. 8B is an exploded, perspective-view illustration of the assembly 800 of FIG. 8A. As illustrated in greater detail in FIG. 8B, the hardware 846 includes securing features 892a at ends of the spokes of the source-side support structure 802a and securing features 892b at ends of the spokes of the support structure 802b on the output side.

As also illustrated in greater detail in FIG. 8B, the disk chopper wheel 801 includes bearings 884 on either side thereof, which are configured to fit into securing features 882a-882b within the support structure portions 802a and 802b, respectively, in order to secure the disk chopper wheel 801 at the rotation axis 840 thereof. The support structure portions 802a and 802b further include features for securing the source-side and output-side scatter plates 803 and 804, respectively. Also illustrated in greater detail in FIG. 8B are an open slot 854 defined by the source-side scatter plate 803, as well as an open slot 856 defined in the output-side scatter plate 804. These open slots, which allow for x-rays to pass through, are further described in connection with FIGS. 9A-9B, 10, 12A-12B, and 13.

FIG. 9A is a cross-sectional profile view of the disk chopper wheel 801, source side and output-side scatter plates 803 and 804, respectively, and the shield structure 805 of the embodiment assembly 800 of FIG. 8A and 8B. As also illustrated in FIG. 9A, the chopper wheel rotates about the rotation axis 840, which is perpendicular to a rotation plane 980 of the chopper wheel 801. In this illustration, the rotation axis 840 coincides with the z-axis in the Cartesian coordinates shown. The rotation plane 980 of the chopper wheel is perpendicular to the rotation axis 840 and lies in a plane parallel to the XY plane in the Cartesian coordinates shown. The source-side scatter plate 803 is secured in a plane 981 that is parallel to the rotation plane 980 of the disk chopper wheel.

As illustrated in FIG. 9A further, the output-side scatter plate 804, like the source-side scatter plate 803, is secured to be substantially parallel to the rotation plane of the disk chopper wheel 801. An output-side gap between the output-side scatter plate and the disk chopper wheel is illustrated in greater detail in FIG. 9B.

FIG. 9B is a magnified view of a portion of the cross-sectional profile illustration shown in FIG. 9A. FIG. 9B particularly illustrates various dimensions of the assembly 800 of FIGS. 8A-8B. The source-side scatter plate 803 has a thickness 968 and a source-side gap 950 between the scatter plate 803 and the chopper wheel 801. The source-side scatter plate 803 further includes the source-side scatter plate having a source-side slot width 990 that allows x-rays to pass through to a source side 976 of the disk chopper wheel 801. When the slot 990 is blocked by a solid portion of the chopper wheel 801, x-ray radiation is blocked from passing through the chopper wheel. On the other hand, as the chopper wheel rotates, when a radial slit of the chopper wheel intersects with the source side slot 854 along a direction of the x-ray travel 844, x-rays 844 pass through the slot 990 and through the radial slit defined in the chopper wheel 801.

The output-side scatter plate 804 similarly has a thickness 970 and an output-side gap 952 between the scatter plate 804 and the output side 978 of the disk chopper wheel.

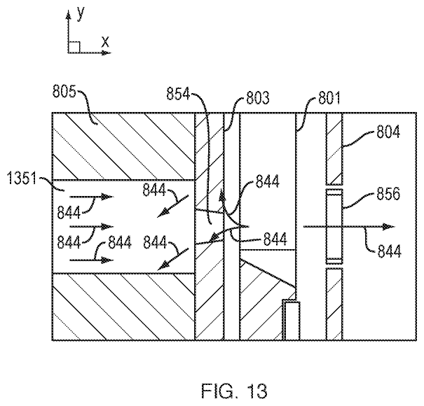

The source-side gap 950 may be in a range of approximately 0.5 mm to approximately 1.0 mm, for example. As this gap increases, leakage of scattered x-rays also increases, as will be understood from the illustration in FIG. 13, for example. Other example source side gaps may be in a range of approximately 0.2 mm to approximately 2.0 mm, approximately 0.5 mm to approximately 1.25 mm, approximately 0.5 mm to approximately 0.75 mm, approximately 0.02 inches to approximately 0.04 inches, or approximately 0.03 inches, for example. In the context of source-side gaps or output-side gaps, as used herein, “approximately” denotes a tolerance of +/−0.25 mm.

As used herein, the source-side scatter plate 803 may be considered to be “substantially parallel” to the rotation plane of the chopper wheel when the source-side scatter plate and rotation plane of the disk chopper wheel are sufficiently parallel such that the chopper wheel may freely rotate without contacting the scatter plate 803. In a similar manner, the output-side scatter plate 804 may be considered to be “substantially parallel” to the chopper wheel 801 when the chopper wheel may freely rotate without risk of contact with the scatter plate 804. Where there is some degree of slight angle between either of the scatter plates and the rotation plane of the chopper wheel, the gap 950 or gap 952 may be considered to be the average distance between the plate 803 and the source side 976 of the disk chopper wheel or the average distance between the scatter plate 804 and the output side 978 of the disk chopper wheel.

FIG. 9B also illustrates that the source-side scatter plate 803 has a source-side plate width 988, measured parallel to the y-axis in FIG. 9B. Similarly, the output-side scatter plate 804 has an output-side plate width 989, similarly measured. The plate widths 988 and 989, which are measured in a direction parallel to a radial direction of the disk chopper wheel along the vertical y-axis in FIG. 9B, may be in a range of about 10% to about 70% greater than a slit length of one of the radial slit openings in the radial direction of the disk chopper wheel. These radial slit lengths are further illustrated in FIG. 11, and the plate widths are further illustrated in FIGS. 12A and 12B, respectively.

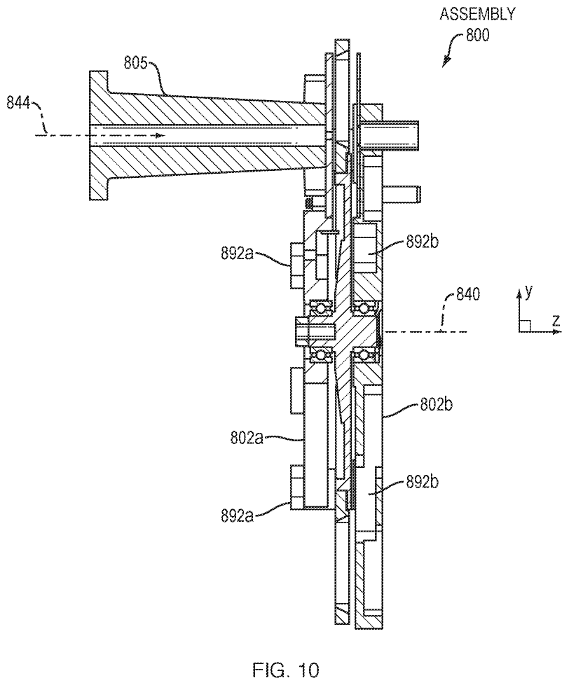

In general, as the plate width increases, leakage of scattered x-rays decreases for a given gap. In general, greater scatter plate width relative to slit length of radial slits in the chopper wheel leads to greater confinement and less leakage of x-rays. The relationship is further illustrated in FIG. 10 for the embodiment of FIGS. 8A-8B, assuming that only the source-side scatter plate in FIGS. 8A-8B is used, since the source-side scatter plate has a much larger impact on reducing x-ray leakage. Nonetheless, substantial confinement can occur with a limited size of a source-side scatter plate, as described herein, leading to operation of an x-ray scanner meeting leakage standards comparable to those of existing designs having full shielding surrounding an entire disk chopper wheel.

As used herein, “substantial confinement” of x-ray radiation denotes that the disk chopper wheel and source-side scatter plate are arranged relative to each other with gaps, plate width, etc. such that x-ray leakage of scattered radiation is reduced to no more than 50% leakage of the radiation that is scattered by the wheel, or to an x-ray radiation dose of no more than 5 milli-Rem per hour at a distance of 5 cm away from an outer surface of the assembly, whichever is greater. The substantial confinement may further include limiting leakage of scattered radiation to no more than 10% of radiation that is scattered by the assembly, or to a radiation dose of no more than 0.5 milli-Rem per hour at a distance of 5 cm away from the outer surface of the assembly, such as from the outer surface of the support structure, whichever is greater. In some disk chopper wheel assemblies within the scope of embodiments, radiation leakage is limited to that which would be achieved by a full shield enclosure surrounding the disk chopper wheel on all sides and having a thickness and material similar to those of a given embodiment source-side scatter plate. In general, X-ray leakage may be limited to that which is considered safe for a particular scanning environment or application by adjusting plate width and gap as desired. “Substantial confinement” as used herein may also be achieved with the aid of an output-side scatter plate, such as the plate 804 of the embodiment assembly 800. “Substantial confinement” as used herein may also be achieved with the aid of the optional shield structure 805 arranged relative to the disk chopper wheel and source-side scatter plate.

Plate width is preferably greater than the lengths of radial slits in the chopper wheel, and the scatter plates all preferably fully overlap in cross section with the radial slits in the scatter plate, in order to enhance shielding. Nonetheless, it is also preferable for scatter plate width to be as small as possible in order to minimize total assembly weight. Accordingly, in example embodiments, as described above, the plate widths 988 and 989 may be in a range of about 10% to about 70% greater than a slit length of one of the radial slit openings. Furthermore, plate widths may be in other example ranges, such as about 5% to about 100%, about 10% to about 80%, about 20% to about 70%, about 30% to about 60%, or about 40% to about 50% greater than the slit length, depending on the plate gaps 950 and 952 and the desired maximum radiation leakage. In the context of plate widths, “about” as used herein denotes a tolerance of +/−5%.

FIG. 10 is a cross-sectional, profile-view illustration of the full assembly 800 illustrated in FIGS. 8A-8B.

FIG. 11 is a cross-sectional profile-view of the disk chopper wheel 801 of the assembly 800 illustrated in FIGS. 8A-8B. The disk chopper wheel 801 has a diameter 1183. Radial directions 1174a and 1174b are shown for the disk chopper wheel. In the illustration of FIG. 11, these radial directions happen to be aligned parallel to the y-axis and x-axis, respectively. A radial slit length 1193 of the radial slit openings is measured along the radial direction. The width of the source-side scatter plate 803 may be only slightly greater than the radial slit length 1193. For example, the plate width may be about 10% to about 70% greater than the radial slit length. The size of the source-side scatter plate relative to the slit length may vary depending on the leakage tolerance. Also illustrated in FIG. 11 is an open cross-sectional area 1187 of the radial slits.

The chopper wheel has a total area 1186, which is the total cross-sectional area of solid portions of the chopper wheel, including solid portions of the inner hub 849 and of the outer disk 848 and excluding the open areas constituting the radial slits and excluding any other holes or openings introduced into the chopper wheel, such as holes in the inner hub 849 illustrated in FIG. 8A. Where wheel slits or other openings include chamfering, the cross-sectional area of the solid portions of the chopper wheel may be considered to be the cross-sectional area through the center of the wheel (in the rotation plane).

FIG. 12A is a cross-sectional profile view of the source-side scatter plate 803 of the embodiment assembly 800. The cross section is in the plane 981 illustrated in FIG. 9A, which is parallel to the rotation plane 980 of the disk chopper wheel. The solid cross-sectional area 1286 may be substantially smaller than the solid cross-sectional area 1186 of the chopper wheel, as illustrated in FIG. 11, and as previously described. In addition to the source-side plate width 988, the plate 803 has a source-side plate length 1285.

FIG. 12B is a cross-sectional profile view of the output-side scatter plate 804, which has a total solid cross-sectional area 1287. This area 1287 may be substantially smaller than the total cross-sectional solid area 1186 of the disk chopper wheel for further advantages beyond those described above in relation to the solid cross-sectional area of the source-side scatter plate 803. Furthermore, the output-side scatter plate may have any of the features described herein in relation to the source-side scatter plate. In the embodiment of FIGS. 8A-8B, the slot width 991 of the output-side plate 804 is greater than the slot width 990 of the source-side scatter plate 803. However, in assemblies of other embodiments, these relative slot widths may differ or be the same. In addition to the output-side plate width 989, the plate 804 has an output-side plate length 1289.

In most existing chopper wheel assemblies, the chopper wheel is completely enclosed by a chopper wheel enclosure in order to provide adequate x-ray shielding and safety. Accordingly, existing assemblies result in the chopper wheel enclosure being at least somewhat larger in cross-sectional area than the chopper wheel. In contrast to the existing assemblies, the solid cross-sectional area of the source-side scatter plate of the embodiment assembly 800, which is illustrated in FIG. 12A in greater detail, advantageously may be substantially smaller than the solid cross-sectional area of the disk chopper wheel.

As used herein, a solid cross-sectional area of the source-side scatter plate is “substantially smaller” than the solid cross-sectional area of the disk chopper wheel of an embodiment assembly when either the source-side plate width 988 or the source-side plate length 1285 of the source-side scatter plate is smaller than the diameter 1183 of the disk chopper wheel. In various embodiments, both the width 988 and length 1285 of the source-side scatter plate may be smaller than the diameter 1183 of the disk chopper wheel.

In assemblies of some embodiment systems, the solid cross-sectional area of the source-side scatter plate may be smaller than a corresponding full enclosure would need to be in an enclosure width or length to enclose the chopper wheel fully. Further, in various embodiments, the source-side scatter plate may be smaller in weight than a corresponding full-shield enclosure would need to be to provide a comparable level of x-ray shielding. In various example embodiments, the solid cross-sectional area of the source-side scatter plate may be less than 90%, less than 70%, less than 50%, less than 40%, less than 30%, less than 25%, less than 15%, or less than 10% of the cross-sectional area 1186 of the disk chopper wheel. Nonetheless, it is preferable for the solid cross-sectional area of the source-side scatter plate to be less than 50%, less than 25%, or less than 10% of the cross-sectional area 1186 of the disk chopper wheel in order to reduce assembly weight the most and obtain maximum benefits of embodiment assemblies over the existing assemblies. This example solid cross-sectional area 1286 of shielding material of the source-side scatter plate, which is significantly reduced relative to a full disk enclosure in various existing designs, is a major advantage of embodiments described herein for reduced weight and material usage. Similar dimensional characteristics may apply to the output-side scatter plate relative to the disk chopper wheel.

FIG. 13 is a cross-sectional profile view showing part of the illustration of FIG. 9B, further magnified to show x-ray confinement properties. The shield structure 805 substantially encloses x-ray radiation 844 in a region of travel 1351 between the x-ray source (not shown in FIG. 13) and the source-side scatter plate 803. Any x-rays 844 that are not traveling straight toward the scatter plate 803, perpendicular to the scatter plate, may be safely absorbed by the shield structure 805. Furthermore, scattered x-rays 844′ that are scattered from the source-side scatter plate may also be safely absorbed by the shield structure 805. The shield structure 805 may be considered to substantially confine x-rays traveling in the region 1351 when any leakage x-rays are reduced to the level that is safe for the assembly to operate.

FIG. 13 further illustrates the operation of the source-side scatter plate 803 to prevent x-ray leakage. When x-rays 844 traverse the slot 854 in the source-side scatter plate and strike a solid portion of the disk chopper wheel 801, the scattered x-rays 844′ are absorbed by the scatter plate, and very few scattered x-rays 844′ escape, assuming that the gap between the source-side scatter plate and chopper wheel is sufficiently small, as already described herein. A similar principle applies to the output-side scatter plate 804, which is used in the assembly illustrated in FIGS. 8A-8B. In the case of the output-side scatter plate 804, most of the scattered x-rays that need to be absorbed are scattered from the edges of the radial slits in the disk chopper wheel 801.

Novel Applications of Embodiment Radiation Scanning Systems and Methods with Reduced Size and Weight

Various embodiment systems described in this application can weigh under 100 lbs, including the source x-ray tube, all shielding, and a ten-inch diameter, 3 mm thick open-geometry disk chopper wheel with the rotation plane thereof tilted at γ=20° with respect to the illuminating fan beam)(α=70°). Tilted disk chopper wheels are described in U.S. patent application Ser. No. 15/527,566, filed Nov. 20, 2015, which is hereby incorporated herein by reference in its entirety. In addition, the dimensions of certain embodiment systems do not exceed 50 cm×40 cm. In comparison, existing hoop and wheel configurations that operate at 225 kV can typically weigh in excess of 300 lbs and be much larger. The relatively small size and weight of the x-ray beam-embodiment forming systems within the scope of this description allow multiple systems to be placed, for example, in a mobile platform such as a backscatter x-ray van. Typically, no more than one existing system could be used in a van, for example, due to the total weight limitations supported by the van chassis. For example, one embodiment radiation scanning system may be used to scan vehicles passing to the left of the van, while another embodiment radiation scanning system may be used to scan vehicles passing to the right of the van. Alternatively, one embodiment radiation scanning system may be placed at a lower height relative to the van chassis to scan vehicles from a substantially sideways direction, and another source subsystem may be placed at a larger height relative to the van chassis to scan vehicles from a more downwards (top-down) direction.

FIG. 14 is a schematic diagram illustrating the embodiment radiation scanning system 100 of FIG. 1 mounted within a vehicle 1483 that is equipped with detectors 1425 that are attached externally thereto in a backscatter detection arrangement. The scanning pencil beam 23 (x-rays, in this embodiment) is swept from the system 100 over a target object car 1411 to scan the car for contraband. Backscattered x-rays 14 are scattered from the car, and the external detector 1425 detects the backscattered x-rays 14. The external detector 1425 is mounted in a fixed manner to the vehicle, such that detector folding, removal, or other reconfiguration is not necessary when the vehicle is driven. FIG. 14, therefore, is a further example illustrating how embodiment system may be used in a variety of scanning environments. Moreover, since the weight of a disk chopper wheel and accompanying scanning system may be dramatically reduced consistent with various embodiments, mobile scanning such as that illustrated in FIG. 14 can be particularly facilitated because a truck or other mobile system may include two or more scanning systems for different scanning directions, different scanning energies, etc.

### Further Details and Features of Certain Embodiment Systems and Methods

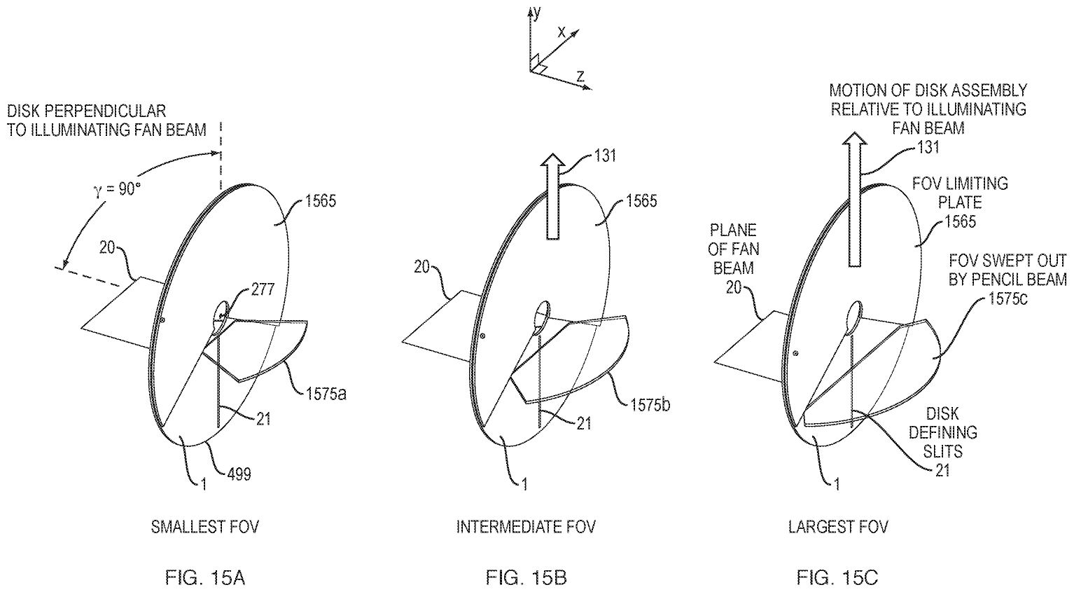

FIGS. 15A-15C are schematic, perspective-view illustrations of the scanning geometry of a system similar to the system 100 of FIG. 1, in which the plane of rotation of the disk chopper wheel is substantially perpendicular to the fan beam plane. In particular, in FIGS. 15A-15C, the fan beam plane 20 is a plane parallel to the XZ plane that is shown, while the plane of rotation of the disk chopper wheel 1 is the XY plane that is illustrated. Accordingly, in each of FIGS. 15A-15C, an angle between the fan beam plane and plane of rotation of the disk chopper wheel is γ=90°. In other embodiments, the disk chopper wheel rotation plane is still substantially normal to the fan beam plane, but not exactly 90°, such as within a range of 60-120°, 75-105°, 80-100°, or 85-95°, for example.

The disk chopper wheel illustrated in FIGS. 15A-15C also includes a FOV-limiting plate 1565, which is configured to allow the FOV of a system to be steered as described in connection with FIGS. 4-6A, for example.

In FIG. 15A, the fan beam plane intersects the plane of rotation of the disk chopper wheel at a position that is closest to the center 277 of the chopper wheel while still intersecting cross-sectionally with the radial slit aperture 21. Accordingly, a relatively small FOV 1575a is swept out by a pencil beam that is formed by the disk chopper wheel 1 as it rotates.

In FIG. 15B, the disk chopper wheel 1 is displaced with an intermediate degree of displacement 131 such that the fan beam plane 20 intersects the disk chopper wheel 1 at an intermediate position. In this manner, the resulting pencil beam sweeps out an intermediate-range FOV 1575b as the disk chopper wheel 1 rotates. In FIG. 15C, the displacement 131 of the chopper disk assembly relative to the source (and relative to the illuminating fan beam) is larger, such that the fan beam plane 20 intersects the disk chopper wheel 1 as close as possible to the periphery 499 of the disk chopper wheel. In this manner, the resulting pencil beam formed by rotation of the disk chopper wheel 1 sweeps out a FOV 1575c, which is the largest FOV to which the chopper wheel assembly may be set with the FOV-limiting plate 1565 as shown.

FIGS. 16A-16C show the same disk chopper wheel assembly of FIGS. 15A-15C, except that the plane of rotation of the disk chopper wheel is not substantially perpendicular to the fan beam plane 20, but is instead at an angle γ=45° with respect to the fan beam plane. This arrangement has the effect of substantially increasing effective thickness of the disk chopper wheel 1 without the need to increase actual thickness of the wheel. This arrangement can result in substantially reduced weight of a disk chopper wheel, even while maintaining shielding requirements met by existing designs.

In FIG. 16A-16C, the disk chopper wheel is rotated with respect to an axis that is parallel to the x-axis. In this arrangement, a relative displacement 1631 between the disk chopper wheel and the fan beam plane can advantageously have a displacement component 1631_{z} that is parallel to the fan beam plane 20, which is parallel to the XZ plane. The relative displacement 1631 illustrated in FIGS. 16B-16C also has a displacement component 1631_{y} that is perpendicular (normal) to the fan beam plane. In particular, in some embodiments, the displacement is parallel to the rotation plane of the disk chopper wheel, as it is in FIGS. 16B-16C. With the angle γ set to 45°, then, relative displacements between the fan beam plane and the disk chopper wheel rotation plane in FIGS. 16A-16C are in a plane parallel to the YZ plane and perpendicular to the X axis, at an angle of 45° relative to the fan beam plane. It will be understood that while these variable, relative displacements are provided by chopper wheel translation in FIGS. 16A-16C, the relative displacements can be provided by translation of the source, as illustrated in FIG. 1, as one alternative, for example.

In FIG. 16A, the fan beam plane 20 is set to intersect the plane of rotation of the disk chopper wheel 1 at a position as close as possible to the center 277 of the disk in order for the resulting pencil beam to sweep out a FOV 1675a. In FIG. 16B, the intermediate displacement 1631 has been effected in the disk chopper wheel, parallel to the plane of rotation of the disk chopper wheel, and at an angle of 45° with respect to the fan beam plane. This intermediate displacement results in an intermediate FOV 1675b being swept out by the scanning pencil beam. In FIG. 16C, a larger relative displacement 1631 has been effected to place the fan beam plane 20 at an intersection position that is closest to the periphery 499 of the disk chopper wheel 1, resulting in the largest FOV 1675c for scanning with the disk chopper wheel assembly that is shown.

In FIGS. 17A-17C, the disk chopper wheel assembly is the same as that illustrated in FIGS. 15A-15C and 16A-16C, except that the angle between the fan beam plane and the disk chopper wheel is set to γ=30°. This results in yet greater effective thickness of the disk chopper wheel 1 than is provided in the arrangement of FIGS. 16A-16C. In other embodiments, the angle between the rotation plane of the disk chopper wheel and the fan beam plane may be less than 30°, less than 15°, or other values in this range, for example.

In FIG. 17A, the position of intersection between the fan beam plane 20 and the plane of rotation of the disk chopper wheel 1 is set as close as possible to the center 277, resulting in the smallest FOV 1775a that is possible with this arrangement. In FIG. 17B, the disk chopper wheel has undergone a relative displacement 1731 with an intermediate magnitude, resulting in the fan beam plane 22 intersecting the disk chopper wheel at an intermediate position. This results in an intermediate FOV 1775b. In FIG. 17C, as in FIG. 17B, the disk chopper wheel has undergone a relative displacement 1731 that is parallel in direction to the plane rotation plane of the disk chopper wheel 1, at 30° relative to the fan beam plane. In FIG. 17C, the relative displacement 1731 is larger than in FIG. 17B, resulting in the fan beam plane 20 intersecting with the rotation plane of the disk chopper wheel at a position that is as close as possible to the periphery 499 of the disk chopper wheel 1, and which sets the FOV to a largest possible value for this chopper wheel assembly and arrangement, FOV 1775c.

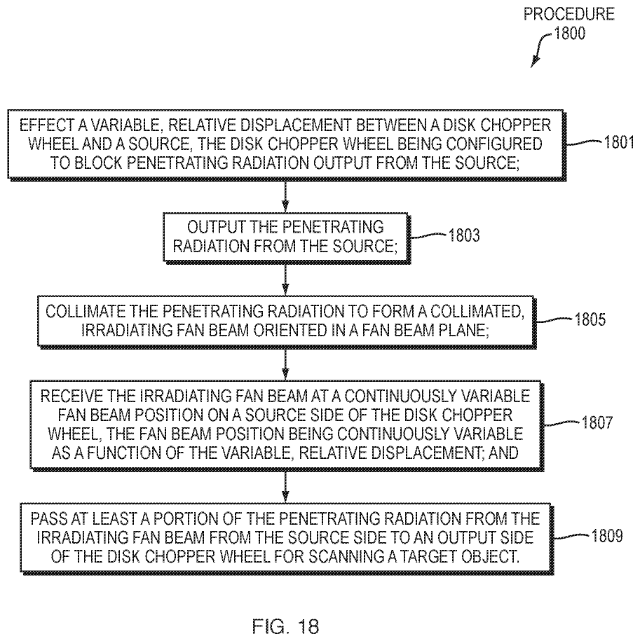

FIG. 18 is a flow diagram illustrating an embodiment procedure 1800 for radiation scanning. At 1801, a variable, relative displacement between a disk chopper wheel and a fan beam plane is effected. The disk chopper wheel is configured to block the penetrating radiation provided by the source. At 1803, the penetrating radiation is output from the source. At 1805, the penetrating radiation is collimated to form a collimated, irradiating fan beam oriented in a fan beam plane.

At 1807, the irradiating fan beam is received at a continuously variable fan beam position on a source side of the disk chopper wheel, the fan beam position being continuously variable as a function of the variable, relative displacement. At 1809, at least a portion of the penetrating radiation from the radiating fan beam is passed from the source side to an output side of the disk chopper wheel for scanning a target object.

In other embodiments, the procedure 1800 may be modified to include use of any of the elements described in connection with other embodiments and drawings described herein.

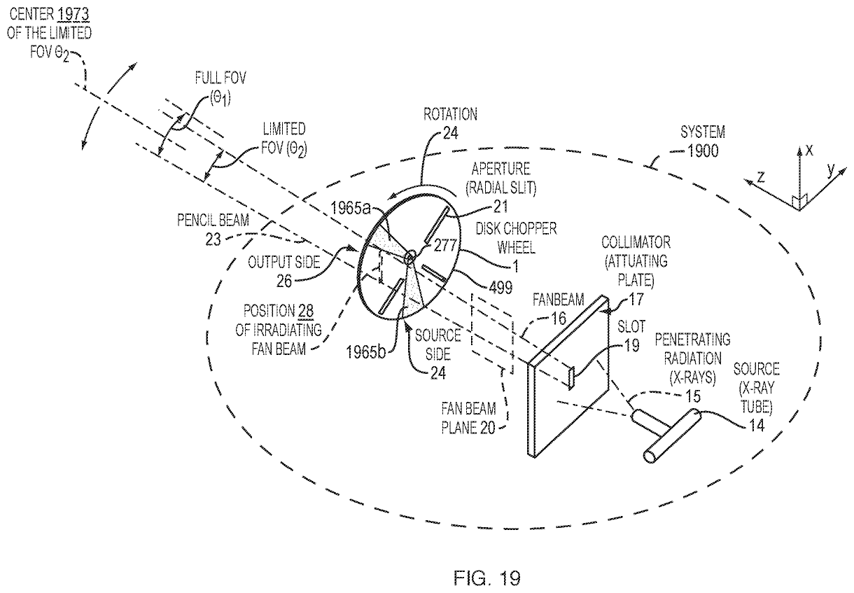

FIG. 19 is a schematic, perspective-view illustration of a system 1900 for radiation scanning. The system 1900 includes many features similar to the features of the system 100 described in connection with FIG. 1, except that the system 1900 does not include a translation mechanism. The source 14 and the disk chopper wheel 1 are fixed in position relative to one another. However, the system 1900 further includes FOV-limiting plates 1965a and 1965b that are similar to the FOV-limiting plates 465a and 465b described in connection with FIGS. 4 and 5A-5C.

The FOV-limiting plates 1965a and 1965b are rotatably adjustable with respect to the center 277 of the disk chopper wheel 1. The plates 1965a and 1965b each extend radially from at or near the rotation axis of the disk chopper wheel (the rotation axis passing through the center 277 of the disk chopper wheel) radially from the rotation axis of the disk chopper wheel, and each of the plates has at least one radial edge that is straight and extends radially with respect to the rotation axis of the disk chopper wheel, similar to the lower edge 467 and upper edge 469 illustrated in FIG. 4. The radial edges may be used to limit and to steer the FOV of the system. Alternatively, two radial edges may be provided by a single FOV-limiting plate such as the FOV-limiting plate illustrated in FIGS. 15A-15C, 16A-16C, and 17A-17C.

It should be understood that the one or more FOV-limiting plates in embodiment systems may have a wide variety of shapes and also locations relative to the disk chopper wheel. An advantageous feature of any embodiment with FOV-limiting plates is that the one or more FOV-limiting plates include two edges that are radial over a range of possible cross-sectional intersection points between the radial slits of the disk chopper wheel and the fan beam plane for purposes of target scanning operations. However, in other respects, one or more FOV-limiting plates may have various configurations, such as covering more or less of the disk chopper wheel area, or such as each of a plurality of FOV-limiting plates in an embodiment system have two radial edges, similar to the plates 1965a and 1965b.

While the FOV size may be adjusted solely by adjusting the FOV-limiting plates, using the system illustrated in FIG. 19, for example, various advantageous embodiments may fix the FOV-limiting plates and then adjust the system's scanning FOV using translation for relative displacement between the disk chopper wheel and the fan beam plane, as previously described. Using translation and the accompanying relative displacement in connection with one or move FOV-limiting plates can

As the plates 1965a and 1965b are rotated with respect to each other, the scanning FOV of the system may be adjusted from a full FOV Θ₁ to a limited FOV Θ₂, to a full range of intermediate FOVs, and back, as described in connection with FIGS. 4-6A. With an appropriate translation mechanism, the displacement may be smooth, with the FOV smoothly variable over its range. Furthermore, if the FOV-limiting plates 1965a and 1965b are rotated together, relative to the disk chopper wheel, within the XY plane illustrated in FIG. 19, for example, a center axis 1973 of the FOV may be adjusted to obtain the benefits described in connection with FIGS. 5A, 6A, and elsewhere herein.

The system 1900 may be modified to form other embodiments including the elements described in connection with any of the drawings and embodiments otherwise described herein. For example, the system 1900 may be modified to include the disk chopper wheel 1 being oriented in a rotation plane that is substantially non-perpendicular to the fan beam plane 20 to increase effective thickness of the wheel. Furthermore, the system 1900 may be modified to include a translation mechanism, similar to the translation mechanisms 129, 229a, 229b, and 229c, as described in connection with FIGS. 1 and 2A-2C, respectively, for example. Furthermore, the system 1900 may be modified to include source-side and/or output-side scatter plates, such as those described in connection with FIGS. 8A-8B, 9A-9B, 10-11, 12A-12B, and 13, for example.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

1. A radiation scanning system comprising:
a source configured to output penetrating radiation;
a collimator configured to collimate the penetrating radiation to form a collimated, irradiating fan beam of the penetrating radiation, the fan beam oriented in a fan beam plane;
a disk chopper wheel that is configured to block the fan beam, the disk chopper wheel configured to receive the fan beam at a fan beam position on a source side of the disk chopper wheel, the disk chopper wheel defining one or more apertures therein that are configured to pass at least a portion of the fan beam from the source side to an output side of the disk chopper wheel for scanning a target object; and
a translation mechanism configured to effect a variable, relative displacement between the disk chopper wheel and the fan beam plane, the variable, relative displacement enabling the fan beam position to be continuously variable.

2. The radiation scanning system of claim 1, wherein the disk chopper wheel is configured to rotate in a rotation plane perpendicular to a rotation axis of the disk chopper wheel, the apertures being radial slit apertures, the system having a full field of view (FOV) defined by an angular range through which a pencil beam output from the disk chopper wheel sweeps upon rotation of the disk chopper wheel, the pencil beam formed by a cross-sectional intersection between the fan beam and a given one of the radial slit apertures, the system further including one or more FOV-limiting plates positioned relative to the disk chopper wheel and defining at least two radial edges, the at least two radial edges defining a limited FOV over which the pencil beam may be output from the disk chopper wheel, the limited FOV being smaller than the full FOV.

3. The radiation scanning system of claim 1, wherein the translation mechanism is further configured to effect the variable, relative displacement between the disk chopper wheel and the fan beam plane in a direction substantially normal to the fan beam plane.

4. The radiation scanning system of claim 1, wherein the translation mechanism is an electromechanical actuator.

5. The radiation scanning system of claim 1, wherein the translation mechanism is a manual actuator.

6. The radiation scanning system of claim 1, wherein the translation mechanism is a slide mechanism.

7. The radiation scanning system of claim 1, wherein the disk chopper wheel is configured to rotate about a rotation axis thereof, the rotation axis being perpendicular to a rotation plane in which the disk chopper wheel is oriented.

8. The radiation scanning system of claim 7, wherein the rotation plane is substantially non-perpendicular relative to the fan beam plane.

9. The radiation scanning system of claim 8, wherein the translation mechanism is further configured to effect the variable, relative displacement between the disk chopper wheel and the fan beam plane with a displacement component that is parallel to the fan beam plane.

10. The radiation scanning system of claim 8, wherein an angle between the rotation plane and the fan beam plane is less than 30°.

11. The radiation scanning system of claim 10, wherein the angle between the rotation plane and the fan beam plane is less than 15°.

12. The radiation scanning system of claim 7, wherein the disk chopper wheel has a rim, the one or more apertures being one or more radial slit apertures extending toward the rim and toward the rotation axis, the one or more radial slit apertures further configured to pass the at least a portion of the fan beam through the one or more radial slit apertures to form a scanning pencil beam, as a function of rotation of the disk chopper wheel, for scanning the target object over an angular field of view (FOV).

13. The radiation scanning system of claim 12, wherein the system has a full FOV resulting from an angular range of rotation of the disk chopper wheel over which the fan beam intersects cross-sectionally with a radial slit aperture of the one or more radial slit apertures, the system further comprising one or more FOV-limiting plates configured to block penetrating radiation from the fan beam or pencil beam to limit the full FOV to a limited FOV that is smaller than the full scanning angular FOV.

14. The radiation scanning system of claim 13, wherein the one or more FOV-limiting plates are configured to be angularly adjustable to change a direction of a central axis of the limited FOV.

15. The radiation scanning system of claim 12, further comprising an electromechanical rotation actuator configured to adjust the one or more FOV-limiting plates angularly relative to the disk chopper wheel.

16. The radiation scanning system of claim 12, further comprising a manual angular adjustment mechanism configured to allow the one or more FOV-limiting plates to be adjusted angularly relative to the disk chopper wheel.

17. The radiation scanning system of claim 7, wherein the disk chopper wheel has a solid cross-sectional area in the plane of rotation,
the system further comprising a source-side scatter plate having a solid cross-sectional area in a plane parallel to the rotation plane of the disk chopper wheel, the source-side scatter plate being substantially opaque to the penetrating radiation and defining an open slot aperture therein configured to pass penetrating radiation, wherein the solid cross-sectional area of the source-side scatter plate is substantially smaller than the solid cross-sectional area of the disk chopper wheel,
the system further comprising a support structure configured to secure the source-side scatter plate substantially parallel to the rotation plane of the disk chopper wheel with a source-side gap between the source-side scatter plate and the source side of the disk chopper wheel.

18. The radiation scanning system of claim 7, wherein the disk chopper wheel has a solid cross-sectional area in the plane of rotation,
the system further comprising an output-side scatter plate having a solid cross-sectional area in a plane parallel to the plane of rotation, the output-side scatter plate being substantially opaque to the penetrating radiation and defining an open slot aperture therein configured to pass the penetrating radiation, wherein the solid cross-sectional area of the output-side scatter plate in the plane parallel to the rotation plane of the disk chopper wheel is substantially smaller than the solid cross-sectional area of the disk chopper wheel,
the system further comprising a support structure configured to secure the output-side scatter plate substantially parallel to the rotation plane of the disk chopper wheel with an output-side gap between the output-side scatter plate and the output side of the disk chopper wheel.

19. The radiation scanning system of claim 1, wherein the translation mechanism is further configured to effect the variable, relative displacement smoothly such that the fan beam position at which the disk chopper wheel is configured to receive the irradiating fan beam is also smoothly variable.

20. The radiation scanning system of claim 1, wherein the translation mechanism is further configured to effect the variable, relative displacement incrementally such that the fan beam position at which the disk chopper wheel is configured to receive the irradiating fan beam is also incrementally variable.

21. A mobile radiation scanning system comprising a plurality of radiation scanning systems according to claim 1.

22. A stationary radiation scanning portal comprising a plurality of radiation scanning systems according to claim 1.

23. A radiation scanning method comprising:
effecting a variable, relative displacement between a disk chopper wheel and a fan beam plane in which a fan beam of penetrating radiation is oriented;
outputting the fan beam of penetrating radiation;
receiving the fan beam at a continuously variable fan beam position on a source side of the disk chopper wheel, the fan beam position being continuously variable as a function of the variable, relative displacement; and
passing at least a portion of the fan beam of penetrating radiation from the source side to an output side of the disk chopper wheel for scanning a target object.

24. A radiation scanning system comprising:
means for effecting a variable, relative displacement between a disk chopper wheel and a fan beam plane in which a fan beam of penetrating radiation is oriented;
means for outputting the fan beam of penetrating radiation
means for receiving the fan beam at a continuously variable fan beam position on a source side of the disk chopper wheel, the fan beam position being continuously variable as a function of the variable, relative displacement; and
means for passing at least a portion of the fan beam of penetrating radiation from the source side to an output side of the disk chopper wheel for scanning a target object .

25. (canceled)

26. (canceled)
